(19) United States
(12) Patent Application Publication
(10) Pub. No.: US 2025/0269572 A1
(43) Pub. Date: Aug. 28, 2025

(54) MOLDING MANAGEMENT SYSTEM

(71) Applicant: SEIKO EPSON CORPORATION, Tokyo (JP)

(72) Inventors: Hiroki ORII, FUJIMI-MACHI (JP); Kosuke ATSUTA, SHIOJIRI-SHI (JP); Soji SHIOZAWA, MATSUMOTO-SHI (JP); Yusuke MITSUMA, SHIOJIRI-SHI (JP)

(21) Appl. No.: 19/062,938

(22) Filed: Feb. 25, 2025

(30) Foreign Application Priority Data
Feb. 28, 2024 (JP) 2024-028148

(51) Int. Cl. B29C 45/76

(52) U.S. Cl. CPC B29C 45/76; B29C 2045/7606; B29C 2945/7629

(57) ABSTRACT

There is provided a molding management system including a server communicably connected to a terminal device, the molding management system managing production of a product in a production process including an injection molding process for the product by an injection molding device. The server includes a storage unit configured to store a plurality of pieces of lot information in which lot identification information for identifying a lot of the product and lot related information including one or more pieces of information concerning the lot of the product are associated with each other and a control unit configured to cause the terminal device to display a lot movement image for receiving lot moving operation for moving the product between a selected pair of the lots among the lots indicated by the plurality of pieces of lot information stored in the storage unit.

The present application is based on, and claims priority from JP Application Serial Number 2024-028148, filed Feb. 28, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product by an injection molding device using a resin material such as plastic has been studied and developed.

Concerning the technique, there is known a system capable of updating, for each molding of a product, control information for controlling molding of the product for each lot (see JP-B-7-029352).

JP-B-7-029352 is an example of the related art.

In the system described in JP-B-7-029352, when movement of a product is performed between two lots at a molding site of the product, for the two lots, a difference sometimes occurs between an actual lot and a lot on the system. This is because lots are managed according to master data on the system. However, this is not desirable in management of the lots.

### SUMMARY

In order to solve the problems described above, an aspect of the present disclosure is a molding management system including a server communicably connected to a terminal device, the molding management system managing production of a product in a production process including an injection molding process for the product by an injection molding device, wherein the server includes: a storage unit configured to store a plurality of pieces of lot information in which lot identification information for identifying a lot of the product and lot related information including one or more pieces of information concerning the lot of the product are associated with each other; and a control unit configured to cause the terminal device to display a lot movement image for receiving lot moving operation for moving the product between a selected pair of the lots among the lots indicated by the plurality of pieces of lot information stored in the storage unit.

### BRIEF DESCRIPTION OF THE DRAWINGS

FIG. 1 is a diagram illustrating an example of a configuration of a molding management system 1.

FIG. 2 is a diagram illustrating an example of a main menu image P1.

FIG. 3 is a diagram illustrating an example of a terminal image P2.

FIG. 4 is a diagram illustrating an example of a lot search image P3.

FIG. 5 is a diagram illustrating an example of a lot movement image P4 displayed when selection operation on a button B41 illustrated in FIG. 4 is performed.

FIG. 6 is a diagram illustrating an example of a state in which lot identification information is input to an input field F61 by an input device such as a keyboard.

FIG. 7 is a diagram illustrating an example of a state in which a pop-up image including a list of lot information respectively indicating lots selectable as a moving destination lot is displayed according to selection operation on the input field F61.

FIG. 8 is a diagram illustrating an example of a state in which gray-out of a button B51 is released by number of products to be moved information being input to an input field F91.

FIG. 9 is a diagram illustrating another example of a lot movement image P4.

FIG. 10 is a diagram illustrating an example of a state of a number of products to be moved reception region RG6 in the case in which permitting to input information to an input field F92 has been selected by a toggle switch TG1.

FIG. 11 is a diagram illustrating another example of a method of inputting shot identification information to the input field F92 illustrated in FIG. 10.

FIG. 12 is a diagram illustrating still another example of the method of inputting the shot identification information to the input field F92 illustrated in FIG. 10.

FIG. 13 is a diagram illustrating an example of a state of the number of products to be moved reception region RG6 in the case in which permitting to input information to an input field F94 has been selected by a toggle switch TG2.

FIG. 14 is a diagram illustrating an example of a state of the number of products to be moved reception region RG6 in the case in which permitting to input information to the input field F92 has been selected by the toggle switch TG1 and permitting to input information to the input field F94 is selected by the toggle switch TG2.

FIG. 15 is a diagram illustrating an example of a product search image P6 displayed by a server 30 when input to the input field F92 and the input field F94 is about to be performed.

FIG. 16 is a diagram illustrating an example of a result of search performed according to selection operation on a pull-down menu performed by a user in FIG. 15.

FIG. 17 is a diagram illustrating another example of the product search image P6.

FIG. 18 is a diagram illustrating an example of a hardware configuration of the server 30.

FIG. 19 is a diagram illustrating an example of a functional configuration of the server 30.

FIG. 20 is a diagram illustrating an example of a flow of processing in which the server 30 moves a product between two lots.

### DESCRIPTION OF EMBODIMENTS

### Embodiment

An embodiment of the present disclosure is explained below with reference to the drawings.

### Overview of a Molding Management System

First, an overview of a molding management system according to the embodiment is explained.

The molding management system according to the embodiment manages production of a product in a production process including an injection molding process of the product by an injection molding device. The molding management system includes a server. The server is communicably connected to a terminal device. The server includes a storage unit and a control unit. The storage unit stores a plurality of pieces of lot information in which lot identification information for identifying a lot of a product and lot related information including one or more pieces of information concerning the lot of the product are associated. The control unit causes the terminal device to display a lot movement image for receiving lot moving operation for moving the product between a selected pair of the lots among lots respectively indicated by a plurality of pieces lot information stored in the storage unit.

Accordingly, the molding management system according to the embodiment can suppress occurrence of a difference between an actual lot in which the product is moved and a lot on the molding management system.

In the following explanation, a configuration of the injection molding system according to the embodiment and processing performed by a server provided in the injection molding system is explained in detail.

### Configuration of the Molding Management System

The configuration of the molding management system according to the embodiment is explained below by taking a molding management system 1 as an example.

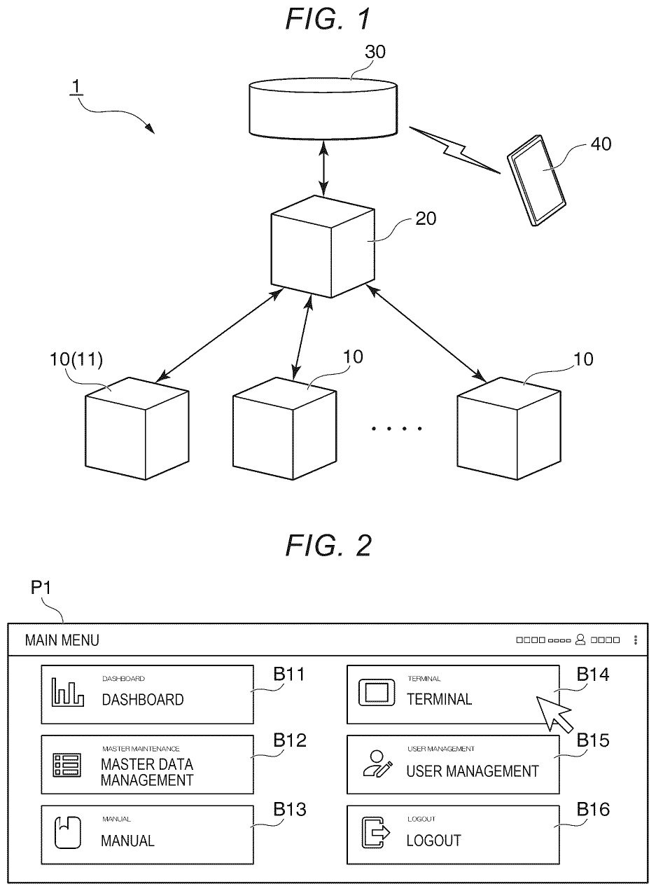

FIG. 1 is a diagram illustrating an example of a configuration of the molding management system 1.

The molding management system 1 is a kind of a manufacturing execution system (MES). For example, the molding management system 1 includes one or more managed devices 10, an information processing device 20, and a server 30. The molding management system 1 may be configured not to include a part or all of the one or more managed devices 10. The molding management system 1 may not include the information processing device 20. In the following explanation, as an example, a case in which the molding management system 1 includes a plurality of managed devices 10 as the one or more managed devices 10 is explained.

Each of the plurality of managed devices 10 provided in the molding management system 1 is a device managed by the molding management system 1. In FIG. 1, for convenience of explanation, the respective plurality of managed devices 10 are indicated by the same reference numerals and signs. However, a part or all of the plurality of managed devices 10 may be devices of types different from one another. The plurality of managed devices 10 include at least one injection molding device that performs injection molding of a product using resin such as plastic. An injection molding device 11 illustrated in FIG. 1 is an example of such an injection molding device. The plurality of managed devices 10 may include an injection molding device that performs metal injection molding (MIM) of a product. In the following explanation, for convenience of explanation, injection molding of a product using resin such as plastic is simply referred to as injection molding. In the following explanation, an injection molding device that performs injection molding of a product using a resin such as plastic is simply referred to as injection molding device. In addition to the injection molding device, the plurality of managed devices 10 include, for example, peripheral equipment of the injection molding device. Examples of the peripheral equipment of the injection molding device include, but are not limited to, a material supply device that supplies a material used by an injection molding device for injection molding of a product to the injection molding device, a conveying device that transports a product injection-molded by an injection molding device, a cleaning device that cleans a product injection-molded by an injection molding device, and a sintering device that sinters a product after being cleaned by a cleaning device. At least one injection molding device included in the plurality of managed devices 10 may be a device that performs injection molding using a material other than resin and metal.

The molding management system 1 manages production of products in a production process including an injection molding process of a product by an injection molding device included in the plurality of managed devices 10. The injection molding device included in the plurality of managed devices 10 may have any configuration if the configuration is capable of producing a product by injection molding. In the following explanation, for convenience of explanation, one time of injection molding of a product by the injection molding device is referred to as one shot. In this case, for example, two shots are two times of injection molding of the product by the injection molding device. In the following explanation, for convenience of explanation, each of one or more hollows in a die filled with resin in molding the product in one shot is referred to as cavity. For example, an injection molding device to which a die having two such hollows is attached molds two products with one shot.

The information processing device 20 acquires, for each of the plurality of managed devices 10, state information indicating a state of the managed device 10 from the managed device 10. For example, the information processing device 20 acquires state information about the injection molding device 11 from the injection molding device 11. Such state information includes a time stamp indicating a date and time when the state information was acquired by the information processing device 20. Certain state information includes device identification information for identifying the managed device 10 in the state indicated by the state information. The state information includes detection information detected by each of one or more various sensors attached to the managed device 10. The detection information includes, for example, information indicating a temperature, information indicating a pressure, information indicating a current value, and information indicating a voltage value. That is, examples of the one or more various sensors include, but are not limited to, a thermometer, a pressure gauge, an ammeter, and a voltmeter. The detection information may include other information detected by the sensor instead of a part or all of these pieces of information or in addition to all of these pieces of information. The state information includes operation state information indicating an operation state of the managed device 10. The operation state information indicating the operation state of the managed device 10 may be any information if the operation state information is information including information indicating whether the managed device 10 is operating. The acquisition of the state information by the information processing device 20 may be periodically performed or may be non-periodically performed. In the following explanation, as an example, a case in which the acquisition of the state information by the information processing device 20 is performed every time the one shot explained above is performed is explained. When acquiring certain state information, the information processing device 20 outputs the acquired state information to the server 30. Accordingly, the information processing device 20 can cause the server 30 to store the acquired state information.

Examples of the information processing device 20 include, but are not limited to, a workstation, a desktop PC (Personal Computer), and a notebook PC. The information processing device 20 is communicably connected to each of the plurality of managed devices 10 by wired or wireless communication. Examples of a communication network that connects the information processing device 20 and each of the plurality of managed devices 10 include, but are not limited to, a Local Area Network (LAN) in a facility in which the plurality of managed devices 10 are installed. The communication network may be another communication network such as the Internet or a mobile communication network.

The server 30 stores the state information acquired from the information processing device 20. For example, when acquiring certain state information from the information processing device 20, the server 30 stores the acquired state information. Here, when the server 30 has already stored state information including device identification information included in the state information, the server 30 replaces the already stored state information with the state information acquired anew. Accordingly, the server 30 can always keep, as the latest state information, the state information indicating the state of the managed device 10 indicated by the device identification information. The server 30 may be configured to store all pieces of acquired state information without performing such replacement. The server 30 may be configured to store the state information before replacement as history information indicating a history of the state of the managed device 10 again even when the server 30 performs such replacement.

According to a request from a terminal device communicably connected to the server 30, the server 30 causes a display unit of the terminal device to display various images based on the state information stored by the server 30. Here, the images are a graphical user interface (GUI), an icon, a window on an operating system (OS), and the like. In the following explanation, as an example, as illustrated in FIG. 1, a case in which the server 30 is communicably connected to a terminal device 40 is explained. In the present embodiment, since processing related to login to the server 30 by the terminal device 40 is known processing, explanation of the processing is omitted. In the following explanation, for convenience of explanation, the server 30 receiving operation from the terminal device 40 via an image displayed on the terminal device 40 is simply referred to as the server 30 receiving operation. That is, in the following explanation, the server 30 performing certain processing according to the received operation means that the server 30 performs the processing according to operation received from the terminal device 40 via the image displayed on the terminal device 40.

The server 30 also receives various information according to the received operation. For example, according to the received operation, the server 30 stores master data including various information about a product by the injection molding device 11. The master data includes, for example, product identification information for identifying various products produced by the injection molding device 11, production quantity plan value information indicating planned values of production quantities of products identified by the respective kinds of product identification information, and die identification information for identifying dies used for production of the products identified by the respective kinds of product identification information. A data structure of the master data may be any structure. For example, the various information included in the master data are included in the master data as information associated with the product identification information.

According to the received operation, the server 30 causes the display unit of the terminal device 40 to display a lot search image for receiving lot search operation for searching for a lot of a product. Examples of the display unit include, but are not limited to, a display of the terminal device 40 and a display device communicably connected to the terminal device 40. In the following explanation, as an example, a case in which the display unit is a display of the terminal device 40 is explained. In the following explanation, for convenience of explanation, causing the display unit to display a certain image is referred to as causing to display the image. The lot search image is an image for receiving, with lot search operation explained above, various information usable as a search key. In the following explanation, for convenience of explanation, a lot of a product is simply referred to as lot. The lot is a group of one or more products to which lot identification information is allocated for a reason of management. For this reason, in the following explanation, for convenience of explanation, a product to which lot identification information for identifying a certain lot is allocated is referred to as product of the lot. The lot identification information may be any information if the information is information capable of identifying a lot and may be, for example, an identifier (ID) for identifying a lot, a character string for identifying a lot, or other information capable of identifying a lot.

Here, the server 30 stores lot identification information and lot related information including one or more pieces of information concerning a lot in association with each other. Accordingly, in the server 30, when information concerning a product of a certain lot is searched, together with lot identification information for identifying the lot, each of one or more pieces of information included in lot related information associated with the lot identification information can also be used as a search key for searching for the lot. In other words, in the lot search image, in addition to the lot identification information, one or more pieces of information included in the lot related information can be used as the search key used for the search for the lot. In the following explanation, for convenience of explanation, information in which lot identification information for identifying a certain lot and lot related information including one or more pieces of information concerning the lot are associated is referred to as lot information indicating the lot. That is, when receiving at least one piece of information among one or more pieces of information included in the lot related information via the lot search image with the lot search operation, the server 30 displays lot information indicating a lot identified by each of one or more pieces of lot identification information associated with the received at least one piece of information. Accordingly, the server 30 can easily cause a user to search for information of a product of a lot desired by the user. For this reason, the server 30 stores a plurality of pieces of lot information for each of the pieces of lot identification information.

For example, the server 30 receives operation via a main menu image P1 illustrated in FIG. 2 to thereby display the lot search image. FIG. 2 is a diagram illustrating an example of the main menu image P1.

When receiving predetermined main menu image display operation, the server 30 displays the main menu image P1. In the example illustrated in FIG. 2, the main menu image P1 includes six buttons B11 to B16.

The button B11 is a button for displaying a dashboard image. When receiving selection operation on the button B11, the server 30 generates a dashboard image and displays the generated dashboard image. Here, the dashboard image is an image in which information necessary for the user to manage production of a product by the injection molding device is displayed during operation of an injection molding device designated by the user of the terminal device 40. In the present embodiment, the selection operation means a click, a tap, or the like but are not limited to these.

The button B12 is a button for displaying a master data management image. When receiving selection operation on the button B12, the server 30 generates a master data management image and displays the generated master data management image. The master data management image is an image for receiving operation of, for example, inputting, changing, and deleting the master data explained above. The server 30 can, for example, generate, change, delete the master data according to operation on the master data management image. When master data is generated, the server 30 stores the generated master data. When the master data is changed, the server 30 updates the stored master data to the changed master data.

The button B13 is a button for displaying a manual image. When receiving selection operation on the button B13, the server 30 generates a manual image and displays the generated manual image. Here, the manual image is an image for receiving operation of displaying a manual for an operation method of the molding management system 1.

The button B14 is a button for displaying a terminal image P2. When receiving selection operation on the button B14, the server 30 generates the terminal image P2 and displays the generated terminal image P2. Here, the terminal image P2 is an image for receiving operation for executing each of various update system functions of the server 30. A certain type of update system function means a function of, for example, inputting, changing, and deleting information corresponding to the type.

The button B15 is a button for displaying a user management image. When receiving selection operation on the button B15, the server 30 generates a user management image and displays the generated user management image. Here, the user management image is an image for receiving operation of, for example, inputting, changing, deleting, and displaying information concerning the user in the information stored in the server 30.

The button B16 is a button for receiving operation of causing the terminal device 40 to log out from the server 30. When receiving selection operation on the button B16, the server 30 causes the terminal device 40 to log out.

In the present embodiment, explanation is omitted about each of the dashboard image, the master data management image, the manual image, and the user management image.

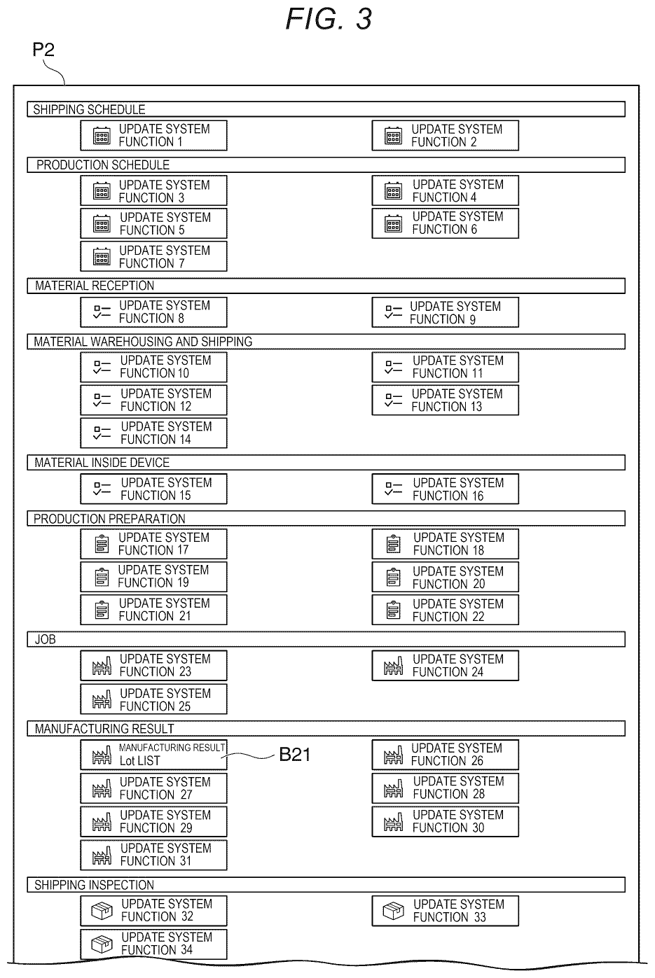

FIG. 3 is a diagram illustrating an example of the terminal image P2. As illustrated in FIG. 3, the terminal image P2 includes buttons for receiving operation of executing each of a plurality of update system functions. One of such buttons is a button B21.

The button B21 is a button for receiving operation of displaying a lot search image P3 that is an example of the lot search image explained above. When receiving selection operation on the button B21, the server 30 generates the lot search image P3 and displays the generated lot search image P3.

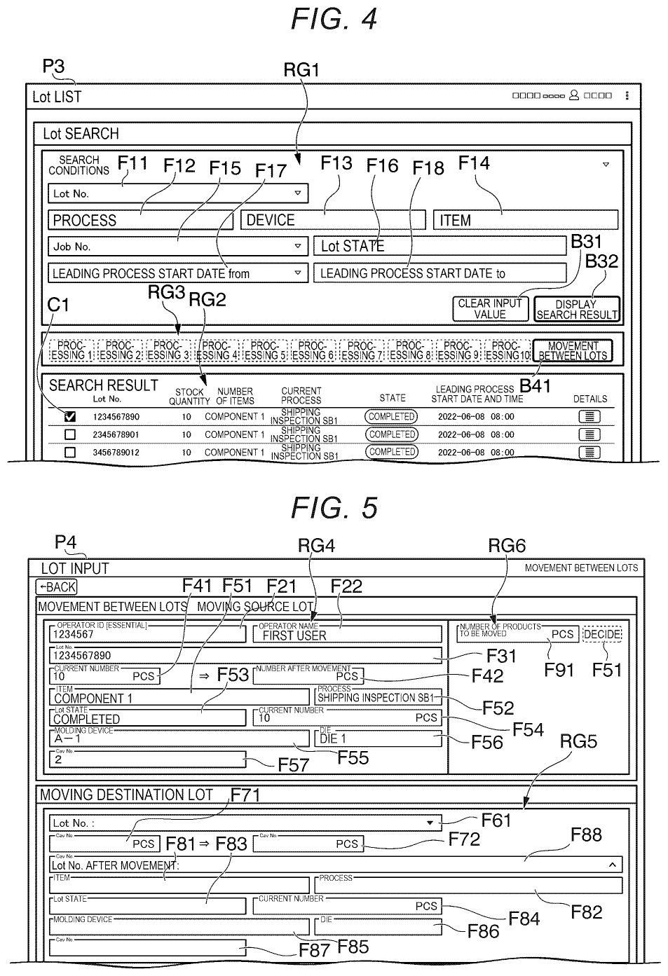

FIG. 4 is a diagram illustrating an example of the lot search image P3. In the example illustrated in FIG. 4, the lot search image P3 includes a lot search region RG1, a search result display region RG2, and a processing button group region RG3.

The lot search region RG1 includes, for example, each of an input field F11 to an input field F18, a button B31, and a button B32. The lot search region RG1 may include, instead of a part or all of these GUIs or in addition to all of these GUIs, another GUI capable of receiving operation of searching for a lot. Here, the lot search operation explained above means individual operation received at the lot search region RG1. In the molding management system 1, the search for a lot is a search for lot information.

The input field F11 is a field to which lot identification information for identifying a lot desired by the user is input. “Lot No.”, which is a character string superimposed on the input field F11 in FIG. 4, is a character string for indicating to the user that information input to the input field F11 is the lot identification information. In the example illustrated in FIG. 4, nothing is input to the input field F11. The input of the lot identification information to the input field F11 may be performed according to selection of the lot identification information by a pull-down menu or may be performed by direct input by an input device such as a keyboard.

The input field F12 is a field to which process information indicating a work process currently performed on a product of a lot desired by the user among various processes included in the production process. Therefore, in the example illustrated in FIG. 4, the lot related information includes the process information. The search for a lot can be performed using the process information as a search key. “Process”, which is a character string superimposed on the input field F12 in FIG. 4, is a character string for indicating to the user that information input to the input field F12 is the process information. In the example, nothing is input to the input field F12. The input of the process information to the input field F12 may be performed according to selection of the process information by a pull-down menu or may be performed by direct input by an input device such as a keyboard.

The input field F13 is a field to which injection molding device identification information for identifying an injection molding device that molded a product of a lot desired by the user or an injection molding device scheduled to mold the product of the lot desired by the user is input. Therefore, in the example illustrated in FIG. 4, the lot related information includes the injection molding device identification information. The search for a lot can be performed using the injection molding device identification information as a search key. “Device”, which is a character string superimposed on the input field F13 in FIG. 4, is a character string for indicating to the user that information input to the input field F13 is the injection molding device identification information. In the example, nothing is input to the input field F13. The input of the injection molding device identification information to the input field F13 may be performed according to selection of the injection molding device identification information by a pull-down menu or may be performed by direct input by an input device such as a keyboard.

The input field F14 is a field to which product type information indicating a type of a product of a lot desired by the user is input. Therefore, in the example illustrated in FIG. 4, the lot related information includes the product type information. The search for a lot can be performed using the product type information as a search key. “Item”, which is a character string superimposed on the input field F14 in FIG. 4, is a character string for indicating to the user that information input to the input field F14 is the product type information. In the example, nothing is input to the input field F14. The input of the product type information to the input field F14 may be performed according to selection of the product type information by a pull-down menu or may be performed by direct input by an input device such as a keyboard.

The input field F15 is a field to which information for identifying a higher-order group to which a lot desired by the user belongs is input. In the following explanation, as an example, a case in which the group is a manufacturing lot is explained. For this reason, in the following explanation, for convenience of explanation, the information is referred to as manufacturing lot identification information. Therefore, in the example illustrated in FIG. 4, the lot related information includes the manufacturing lot identification information. The search for a lot can be performed using the manufacturing lot identification information as a search key. The group may be another group such as a work shift of an administrator who manages production of a product of a lot. “Job No.”, which is a character string superimposed on the input field F15 in FIG. 4, is a character string for indicating to the user that information input to the input field F15 is the manufacturing lot identification information. In the example, nothing is input to the input field F15. The input of the manufacturing lot identification information to the input field F15 may be performed according to selection of the manufacturing lot identification information by a pull-down menu or may be performed by direct input by an input device such as a keyboard.

The input field F16 is a field to which lot state information indicating a state of a lot desired by the user is input. Therefore, in the example illustrated in FIG. 4, the lot related information includes the lot state information. The search for a lot can be performed using the lot state information as a search key. “Lot state”, which is a character string superimposed on the input field F16 in FIG. 4, is a character string for indicating to the user that information input to the input field F16 is the lot state information. In the example, nothing is input to the input field F16. The lot state information is, for example, information indicating any state such as a state in which a lot is stopped, a state in which a lot is being set out, a state in which a lot is on standby, or a state in which a lot is completed. In the following explanation, for convenience of explanation, the state in which a lot is stopped is simply referred to as lot stopped. In the following explanation, for convenience of explanation, the state in which a lot is being set out is simply referred to as lot set out. In the following explanation, for convenience of explanation, the state in which a lot is on standby state is simply referred to as lot on standby. In the following explanation, for convenience of explanation, the state in which a lot is completed is simply referred to as lot completed. The input of the lot state information to the input field F16 may be performed according to selection of the lot state information by a pull-down menu or may be performed by direct input by an input device such as a keyboard.

The input field F17 and the input field F18 are fields to which period information indicating a period including year, month, and day when production of a product of a lot desired by the user was started is input. Therefore, in the example illustrated in FIG. 4, the lot related information includes information indicating the year, month, and day. The search for a lot can be performed using the information as a search key. “Leading process start date from”, which is a character string superimposed on the input field F17 in FIG. 4, is a character string indicating to the user that information input to the input field F17 is start date and time information indicating a date and time when the period starts. “Leading process start date to”, which is a character string superimposed on the input field F18 in FIG. 4, is a character string indicating to the user that information input to the input field F18 is end date and time information indicating a date and time when the period ends. In the example, nothing is input to the input field F17 and the input field F18. The input of the start date and time information to the input field F17 may be performed according to selection of year, month and day by a calendar or the like, and selection of time by a timepiece or the like, or may be performed by direct input by an input device such as a keyboard. The input of the end date and time information to the input field F18 may be performed according to selection of year, month, and day by a calendar or the like, and selection of time by a timepiece or the like, or may be performed by direct input by an input device such as a keyboard. The start date and time information may be information indicating only year, month, and day. The end date and time information may be information indicating only year, month, and day.

The button B31 is a button for receiving operation of deleting respective pieces of information input to a part or all of the input field F11 to the input field F18. In other words, the button B31 is a button for receiving operation of clearing respective pieces of information input to a part or all of the input field F11 to the input field F18. When selection operation on the button B31 is performed, the server 30 deletes respective pieces of information input to a part or all of the input field F11 to the input field F18.

The button B32 is a button for receiving operation of executing a search for a lot based on respective pieces of information input to a part or all of the input field F11 to the input field F18. When selection operation on the button B32 is performed, the server 30 extracts one or more pieces of lot information including respective pieces of information input to a part or all of the input field F11 to the input field F18 out of a plurality of pieces of lot information stored in advance. After extracting one or more pieces of lot information, the server 30 displays a list of the extracted one or more pieces of lot information in the search result display region RG2. In the following explanation, for convenience of explanation, the list is simply referred to as lot information list.

Here, the lot information is, for example, information generated or updated via one of update system functions executable in the terminal image P2 according to information received from the user and is information stored in the server 30. Certain lot information includes, for example, lot identification information for identifying a lot indicated by the lot information and lot related information about the lot. More specifically, the lot related information includes number of products information indicating the number of products of the lot, product type information indicating the type of the product of the lot, process information indicating a work process currently performed on the product of the lot, lot state information indicating a state of the lot, start date and time information indicating a date and time when the production of the product of the lot was started, quality information indicating a result of quality inspection performed on the product of the lot, injection molding device related information concerning an injection molding device that performs molding of the product of the lot, die identification information for identifying a die attached to the injection molding device, and number of cavities information indicating the number of cavities of the die. The quality information is information indicating that, when quality inspection for the product is not performed, the quality inspection for the product is not performed. The injection molding device related information means, for example, information including injection molding device identification information for identifying the injection molding device, operation state information indicating an operation state of the injection molding device, and detection information about the injection molding device. The lot related information may include other information concerning the lot instead of a part or all of these kinds of information or in addition to all of these kinds of information.

The search result display region RG2 is a region where the lot information list is displayed as a result of the selection operation on the button B32 being performed. In the search result display region RG2, when the selection operation on the button B32 is not performed, a list of all pieces of lot information stored in the server 30 may be displayed or nothing may be displayed. In the example illustrated in FIG. 4, the list is displayed in the search result display region RG2. The number of pieces of lot information displayed in the search result display region RG2 may be determined in advance. In this case, a button for displaying the lot information that could not be displayed in the search result display region RG2 is included in the search result display region RG2.

In the example illustrated in FIG. 4, the lot information displayed in the search result display region RG2 includes a part of the lot related information together with the lot identification information. Specifically, the lot information includes each of the lot identification information, the number of products information, the product type information, the process information, the lot state information, and the start date and time information. The lot information may include all pieces of the lot related information together with the lot identification information. For example, lot information displayed at the top part of the search result display region RG2 illustrated in FIG. 4 includes “1234567890” as the lot identification information, includes “10” as the number of products information, includes “component 1” as the product type information, includes “shipping inspection SB1” as the process information, includes lot state information indicating lot completed, and includes “2022 Jun. 8 08:00” as the start date and time information. Here, the “10” is the number of products information indicating ten products. The “2022 Jun. 8 08:00” is start date and time information indicating 08:00 on Jun. 8, 2022.

In respective pieces of lot information displayed in the search result display region RG2, a not-illustrated detailed display button is incidentally displayed. A detailed display button displayed incidental to certain lot information is a button for receiving operation of displaying a detailed information display image in which detailed information of a lot indicated by the lot information is displayed. The detailed information displayed in the detailed information display image includes at least a part of information displayed in the search result display region RG2 in information included in the lot information and at least a part of information not displayed in the search result display region RG2 in the information included in the lot information.

Here, as described above, one or more pieces of information included in lot related information of certain lot information are associated with lot identification information included in the lot information. For this reason, the server 30 can extract the lot information from a storage area of the server 30 using the lot identification information. This not only leads to simplification of a data structure of lot information but also leads to reducing a load of search processing for a lot by the server 30 and is useful.

In the search result display region RG2, when one or more pieces of lot information are displayed, a check box for receiving operation of selecting each of the one or more pieces of lot information is displayed. For example, the check box C1 illustrated in FIG. 4 is a check box for receiving operation of selecting the lot information displayed at the top part of the search result display region RG2. In the search result display region RG2, a checkbox for receiving operation of selecting all pieces of lot information displayed in the search result display region RG2 may be displayed. Accordingly, the server 30 can reduce time and effort required for selection of lot information by the user. In the following explanation, for convenience of explanation, such operation of selecting lot information via the check box is referred to as lot information selection operation. Selection of certain lot information may be referred to as selection of a lot indicated by the lot information.

The processing button group region RG3 is a region where a GUI for receiving processing execution operation of causing the server 30 to start executing predetermined processing on a lot indicated by each of one or more pieces of lot information selected according to received lot information selection operation among one or more pieces of lot information displayed in the search result display region RG2 is displayed. In the example illustrated in FIG. 4, eleven buttons are displayed in the processing button group region RG3 as such a GUI. In the example, the eleven buttons include a button B41. In the present embodiment, explanation is omitted about buttons other than the button B41 among the eleven buttons.

The button B41 is a button for receiving lot movement processing execution operation for starting the server 30 to execute processing of selecting, as a moving source lot, a lot selected by the user in the search result display region RG2 and moving a product between the moving source lot and a moving destination lot. The moving destination lot means a lot selected by the user as a lot at a moving destination to which the product is moved from the moving source lot in a lot movement image P4 explained below. When a predetermined gray-out condition is satisfied, the server 30 grays out the button B41 and does not receive selection operation on the button B41. On the other hand, when the gray-out condition is not satisfied, the server 30 releases the gray-out of the button B41 and receives selection operation on the button B41. According to such gray-out, the server 30 can suppress erroneous operation by the user. The gray-out condition is, for example, conditions including two conditions of the following conditions 1A and 1B.
Condition 1A: a plurality of lots are selected by the user in the search result display region RG2
Condition 1B: no lot is selected by the user in the search result display region RG2

When one of the condition 1A and the condition 1B is satisfied, the server 30 determines that the gray-out condition is satisfied. On the other hand, when both of the condition 1A and the condition 1B are not satisfied, the server 30 determines that the gray-out condition is not satisfied.

Here, in the example illustrated in FIG. 4, among the plurality of lots displayed in the search result display region RG2, a lot displayed at the top part is selected by the user and the other lots are not selected. For this reason, in the example, the button B41 is not grayed out.

The button B41 may be a button for receiving lot movement processing execution operation of causing the server 30 to start execution of processing of designating, as a moving destination lot, a lot selected by the user in the search result display region RG2 and moving a product between the moving source lot and a moving destination lot. In this case, the moving source lot means a lot selected by the user as a lot at a moving source from which the product is moved to the moving destination lot in the lot movement image P4 explained below. In the following explanation, for convenience of explanation, two lots of the moving source lot and the moving destination lot are simply referred to as two lots.

When selection operation on the button B41 is performed, the server 30 displays the lot movement image P4 for receiving lot moving operation of specifying, as a moving source lot, a lot selected by the user in the search result display region RG2 and moving the product between the two lots.

FIG. 5 is a diagram illustrating an example of the lot movement image P4 displayed when selection operation on the button B41 illustrated in FIG. 4 is performed. The server 30 may be configured to display the lot movement image P4 as popup, may be configured to display the lot movement image P4 as one of images included in the lot search image P3, may be configured to display the lot movement image P4 in another window, or may be configured to display the lot movement image P4 with another method.

As illustrated in FIG. 5, the lot movement image P4 includes, for example, three regions, that is, a moving source lot information display region RG4, a moving destination lot information display region RG5, and a number of products to be moved reception region RG6. The lot movement image P4 may include another GUI for receiving lot moving operation instead of a part or all of these GUIs.

The moving source lot information display region RG4 includes a GUI for displaying lot information indicating a moving source lot. More specifically, the moving source lot information display region RG4 includes, for example, a GUI to which information about the user who moves a product between two lots is input, a GUI to which lot identification information for identifying a moving source lot is input, a GUI on which information indicating a change in the number of products of the moving source lot before and after the movement is displayed, and a GUI on which lot information indicating the moving source lot is displayed. The moving source lot information display region RG4 may include another GUI that displays the lot information indicating the moving source lot instead of a part or all of these GUIs or in addition to all of these GUIs.

In the example illustrated in FIG. 5, the moving source lot information display region RG4 includes an input field F21 and an input field F22 as a GUI to which information about the user who moves a product between two lots is input. The GUI may include, instead of one or both of the input field F21 and the input field F22 or in addition to both the input field F21 and the input field F22, another GUI to which the information about the user who moves the product between the two lots is input.

The input field F21 is a field to which user identification information for identifying the user who moves the product between the two lots is input. “Operator ID”, which is a character string superimposed on the input field F21 in FIG. 5, is a character string for indicating to the user that information input to the input field F21 is the user identification information. In default, for example, user identification information about the user logging in to the server 30 is input to the input field F21. A specifying method for the user identification information by the server 30 may be a known method or may be a method to be developed in future. In the example illustrated in FIG. 5, “1234567” is input to the input field F21 as the user identification information input to default. Input of the user identification information to the input field F21 other than the input of the user identification information in default may be performed according to selection of the user identification information by a pull-down menu or may be directly performed by an input device such as a keyboard.

The input field F22 is a field to which user name information indicating a name of the user who moves the product between the two lots is input. “Operator name”, which is a character string superimposed on the input field F22 in FIG. 5, is a character string for indicating to the user that information input to the input field F22 is the user name information. In default, for example, user name information about the user logging in to the server 30 is input to the input field F22. A specifying method for the user name information by the server 30 may be a known method or may be a method to be developed in future. In the example illustrated in FIG. 5, “first user” is input to the input field F22 as the user name information input to default. Input of the user name information to the input field F22 other than the input of the user name information in default may be performed according to selection of the user name information by a pull-down menu or may be directly performed by an input device such as a keyboard.

In the example illustrated in FIG. 5, the moving source lot information display region RG4 includes an input field F31 as a GUI to which lot identification information for identifying a moving source lot is input. The GUI may include, instead of the input field F31 or in addition to the input field F31, another GUI to which lot identification information for identifying the moving source lot is input. The input field F31 is an example of a moving source selection image.

The input field F31 is a field to which lot identification information for identifying a lot selected by the user as a moving source lot is input. “Lot No.”, which is a character string superimposed on the input field F31 in FIG. 5, is a character string indicating to the user that the information input to the input field F31 is the lot identification information. In default, for example, lot identification information for identifying a lot specified as a moving source lot by the server 30 according to the selection operation on the button B41 in the lot search image P3 is input to the input field F31. In the example illustrated in FIG. 5, “1234567890” is input to the input field F31 as the lot identification information. The lot identification information input to the input field F31 may be changeable. In this case, the user can change the lot selected as the moving source lot to another lot by changing the lot identification information input to the input field F31. In such a case, the input of the lot identification information to the input field F31 may be performed according to selection of the lot identification information by a pull-down menu or may be performed directly by an input device such as a keyboard.

Further, in the example illustrated in FIG. 5, the moving source lot information display region RG4 includes a display field F41 and a display field F42 as a GUI on which information indicating a change in the number of products of the moving source lot before and after the movement of the product between the two lots is displayed. The GUI may include, instead of one or both of the display field F41 and the display field F42 or in addition to both of the display field F41 and the display field F42, another GUI on which the information indicating the change in the number of products of the moving source lot before and after the movement of the product between the two lots is displayed.

The display field F41 is a field in which number of products information indicating the number of products of a moving source lot identified by the lot identification information input to the input field F31, the number being a number before the movement of the product is performed, is displayed. “Current number”, which is a character string superimposed on the display field F41 in FIG. 5, is a character string for indicating to the user that information displayed in the display field F41 is the number of products information. In the example illustrated in FIG. 5, “10” indicating ten products is input to the display field F41 as the number of products information.

The display field F42 is a field in which number of products information indicating the number of products of a moving source lot identified by the lot identification information input to the input field F31, the number being a number after the movement of the product is performed, is displayed. “Number after movement”, which is a character string superimposed on the display field F42 in FIG. 5, is a character string for indicating to the user that information displayed in the display field F42 is the number of products information. In the example illustrated in FIG. 5, nothing is input to the display field F42 as the number of products information. This is because the state of the lot movement image P4 illustrated in FIG. 5 is a state before the number of products moved between the two lots is received.

In the example illustrated in FIG. 5, the moving source lot information display region RG4 includes each of a display field F51 to a display field F57 as a GUI on which lot information indicating a moving source lot is displayed. The GUI may include, instead of a part or all of the display field F51 to the display field F57 or in addition to all of the display field F51 to the display field F57, another GUI on which the lot information indicating the moving source lot is displayed.

The display field F51 is a field in which product type information indicating a type of a product of the moving source lot identified by the lot identification information input to the input field F31 is displayed. “Item”, which is a character string superimposed on the display field F51 in FIG. 5, is a character string for indicating to the user that information displayed in the display field F51 is the product type information. In the example illustrated in FIG. 5, “component 1” is displayed in the display field F51 as the product type information.

The display field F52 is a field in which process information indicating a work process currently performed on the product of the moving source lot identified by the lot identification information input to the input field F31 is displayed. “Process”, which is a character string superimposed on the display field F52 in FIG. 5, is a character string for indicating to the user that information displayed in the display field F52 is the process information. In the example illustrated in FIG. 5, “shipping inspection SB1” is displayed in the display field F52 as the process information.

The display field F53 is a field in which lot state information indicating a state of the moving source lot identified by the lot identification information input to the input field F31 is displayed. “Lot state”, which is a character string superimposed on the display field F53 in FIG. 5, is a character string for indicating to the user that information displayed in the display field F53 is the lot state information. In the example, “completed” indicating lot completed is displayed in the display field F53 as the lot state information.

The display field F54 is a field in which number of products information indicating the number of products of the moving source lot identified by the lot identification information input to the input field F31, the number being a number before movement of the product is performed, is displayed. “Current number”, which is a character string superimposed on the display field F54 in FIG. 5, is a character string for indicating to the user that information displayed in the display field F54 is the number of products information. In the example illustrated in FIG. 5, “10” indicating ten products is displayed in the display field F54 as the number of products information.

The display field F55 is a field in which injection molding device identification information for identifying an injection molding device that molded the product of the moving source lot identified by the lot identification information input to the input field F31 or an injection molding device scheduled to mold the product of the lot is displayed. “Molding device”, which is a character string superimposed on the display field F55 in FIG. 5, is a character string for indicating to the user that the information displayed in the display field F55 is the injection molding device identification information. In the example, “A-1” is displayed in the display field F55 as the injection molding device identification information.

The display field F56 is a field in which die identification information for identifying a die attached to an injection molding device that molded the product of the moving source lot identified by the lot identification information input to the input field F31 or a die to be attached to an injection molding device scheduled to mold the product of the lot is displayed. “Die”, which is a character string superimposed on the display field F56 in FIG. 5, is a character string for indicating to the user that information displayed in the display field F56 is the die identification information. In the example, “die 1” is displayed in the display field F56 as the die identification information. The display field F57 is a field in which number of cavities information indicating the number of cavities of the die indicated by the die identification information input to the display field F56 is displayed. “Cav No.”, which is a character string superimposed on the display field F57 in FIG. 5, is a character string for indicating to the user that information displayed in the display field F57 is the number of cavities information. In the example, “2” indicating two cavities is displayed in the display field F57 as the number of cavities information.

The moving destination lot information display region RG5 includes a GUI for displaying lot information indicating a moving destination lot. More specifically, the moving destination lot information display region RG5 includes, for example, a GUI to which the lot identification information for identifying the moving destination lot is input, a GUI on which information indicating a change in the number of products of the moving destination lot before and after movement of a product between two lots is displayed, and a GUI on which the lot information indicating the moving destination lot is displayed. The moving destination lot information display region RG5 may include, instead of a part or all of these GUIs or in addition to all of these GUIs, another GUI that displays the lot information indicating the moving destination lot.

In the example illustrated in FIG. 5, the moving destination lot information display region RG5 includes an input field F61 as a GUI to which lot identification information for identifying a moving destination lot is input. The GUI may include, instead of the input field F61 or in addition to the input field F61, another GUI to which the lot identification information for identifying the moving destination lot is input. The input field F61 is an example of a moving destination selection image.

The input field F61 is a field to which lot identification information for identifying a lot selected by the user as a moving destination lot is input. “Lot No.”, which is a character string superimposed on the input field F61 in FIG. 5, is a character string indicating to the user that information input to the input field F61 is the lot identification information. In the example illustrated in FIG. 5, nothing is input to the input field F61. This is because the state of the lot movement image P4 illustrated in FIG. 5 is a state before the lot identification information is input to the input field F61. The input of the lot identification information to the input field F61 may be performed according to selection of the lot identification information by a pull-down menu, may be performed by direct input by an input device such as a keyboard, may be performed by reading a barcode or the like indicating lot information, or may be performed according to selection of a lot by a popup image including a list of lot information indicating respective lots selectable as a moving destination lot.

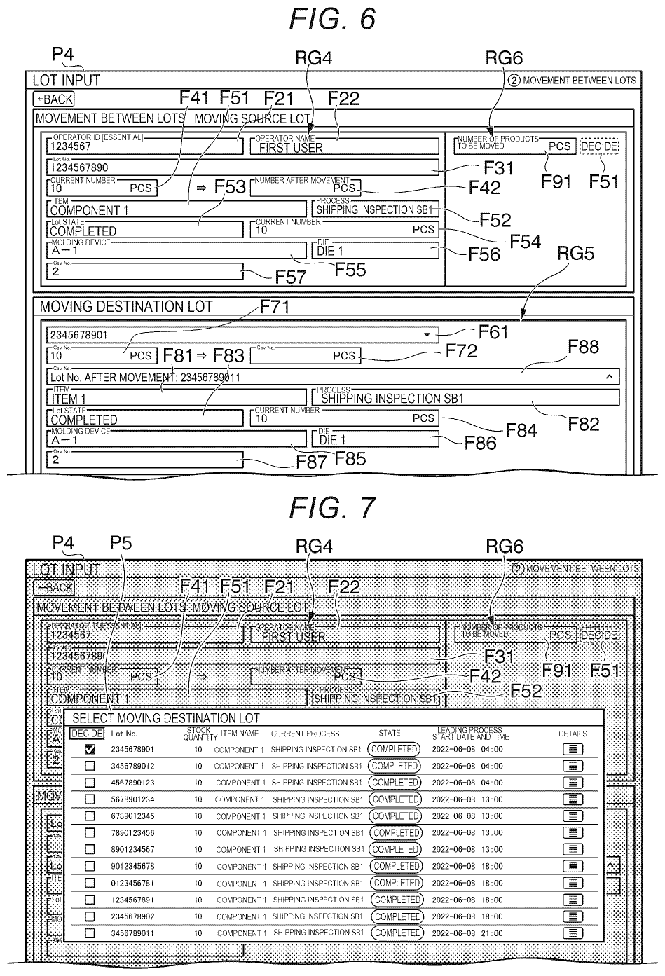

FIG. 6 is a diagram illustrating an example of a state in which lot identification information is input to the input field F61 by an input device such as a keyboard. In the example illustrated in FIG. 6, “2345678901” is input to the input field F61 as lot identification information for identifying a lot selected by the user as a moving destination lot.

FIG. 7 is a diagram illustrating an example of a state in which a popup image including a list of lot information indicating respective lots selectable as a moving destination lot is displayed according to selection operation on the input field F61. For example, when selection operation on a mark “v” included in the input field F61 is performed, the server 30 displays the popup image to be superimposed on the lot movement image P4. An image P5 illustrated in FIG. 7 is an example of the popup image. In the example illustrated in FIG. 7, a display form of the list displayed on the image P5 is the same as the display form of the lot information list displayed in the search result display region RG2 of the lot search image P3. These display formats may be different from each other. For example, when receiving operation of selecting one of lot information included in the list displayed on the image P5, the server 30 deletes the display of the image P5 and inputs lot identification information included in the lot information selected by the received operation to the input field F61. In the example, the selection of the lot information by the user is received by check boxes displayed incidentally to the respective pieces of lot information displayed on the image P5. The selection of the lot information by the user on the image P5 may be received by another method.

When the lot identification information is input to the input field F61, the server 30 generates, based on the lot identification information input to the input field F61, lot identification information allocated anew to a moving destination lot after the movement of the product between the two lots is performed. In the following explanation, for convenience of explanation, the lot identification information is referred to as lot identification information after movement. For example, when the lot identification information input to the input field F61 is an ID in which ten integers of a combination of numbers 0 to 9 are arranged, the server 30 generates, as the lot identification information after movement, an ID in which eleven numbers obtained by adding a predetermined number to the last of the arrangement of the ten numbers are arranged. For example, when the lot identification information input to the input field F61 is “2345678901” and the predetermined number is 1, the server 30 generates “23456789011” as the lot identification information after movement. Accordingly, the user can specify, simply by viewing the lot identification information after movement, which lot is the moving destination lot before the movement of the product between the two lots is performed. Such a method of generating the lot identification information after movement is merely an example and may be another method of generating the lot identification information after movement based on the lot identification information input to the input field F61. The server 30 may be configured to use “2345678901”, which is the lot identification information input to the input field F61, directly as the lot identification information after movement without changing. Even if the server 30 generates the lot identification information after movement, the server 30 does not allocate the lot identification information after movement to the moving destination lot until the movement of the product between the two lots is decided. The server 30 may be configured to allocate new lot identification information to a moving source lot after the movement of the product between the two lots is performed. The server 30 may be configured not to allocate new lot identification information to each of the moving source lot and the moving destination lot after the movement of the product between the two lots is performed. Such allocation of the new lot identification information to the lot may be referred to as update of the lot identification information.

In the example illustrated in FIG. 5, the moving destination lot information display region RG5 includes each of a display field F71 and a display field F72 as a GUI on which information indicating a change in the number of products of the moving destination lot before and after the movement of the product between the two lots is displayed. The GUI may include, instead of one or both of the display field F71 and the display field F72 or in addition to both of the display field F71 and the display field F72, another GUI in which information indicating a change in the number of products of the moving destination lot before and after the movement of the product between the two lots is displayed.

The display field F71 is a field in which number of products information indicating the number of products of the moving destination lot identified by the lot identification information input to the input field F61, the number being a number before the movement of the product is performed, is displayed. “Current number”, which is a character string superimposed on the display field F71 in FIG. 5, is a character string for indicating to the user that information displayed in the display field F71 is the number of products information. In the example illustrated in FIG. 5, nothing is input to the display field F71 as the number of products information. This is because the lot identification information is not input to the input field F61 in the lot movement image P4 illustrated in FIG. 5.

The display field F72 is a field in which the number of products information indicating the number of products of the moving destination lot identified by the lot identification information input to the input field F61, the number being a number after the movement of the product is performed, is displayed. “Number after movement”, which is a character string superimposed on the display field F72 in FIG. 5, is a character string for indicating to the user that information displayed in the display field F72 is the number of products information. In the example illustrated in FIG. 5, nothing is input to the display field F72 as the number of products information. This is because the state of the lot movement image P4 illustrated in FIG. 5 is a state before the number of products moved between the two lots is received.

In the example illustrated in FIG. 5, the moving destination lot information display region RG5 includes each of a display field F81 to a display field F88 as a GUI on which lot information indicating a moving destination lot is displayed. The GUI may include, instead of a part or all of the display field F81 to the display field F88 or in addition to all of the display field F81 to the display field F88, another GUI in which lot information indicating a moving destination lot is displayed.

The display field F81 is a field in which the product type information indicating the type of the product of the moving destination lot identified by the lot identification information input to the input field F61 is displayed. “Item”, which is a character string superimposed on the display field F81 in FIG. 5, is a character string for indicating to the user that information displayed in the display field F81 is the product type information. In the example illustrated in FIG. 5, nothing is displayed in the display field F81. This is because the lot identification information is not input to the input field F61 in the lot movement image P4 illustrated in FIG. 5.

The display field F82 is a field in which process information indicating a work process currently performed on the product of the moving destination lot identified by the lot identification information input to the input field F61 is displayed. “Process”, which is a character string superimposed on the display field F82 in FIG. 5, is a character string for indicating to the user that information displayed in the display field F82 is the process information. In the example illustrated in FIG. 5, nothing is displayed in the display field F82. This is because the lot identification information is not input to the input field F61 in the lot movement image P4 illustrated in FIG. 5.

The display field F83 is a field in which the lot state information indicating the state of the moving destination lot identified by the lot identification information input to the input field F61 is displayed. “Lot state”, which is a character string superimposed on the display field F83 in FIG. 5, is a character string for indicating to the user that the information displayed in the display field F83 is the lot state information. In the example, nothing is displayed in the display field F53. This is because the lot identification information is not input to the input field F61 in the lot movement image P4 illustrated in FIG. 5.

The display field F84 is a field in which number of products information indicating the number of products of the moving destination lot identified by the lot identification information input to the input field F61, the number being a number before the movement of the product is performed, is displayed. “Current number”, which is a character string superimposed on the display field F84 in FIG. 5, is a character string for indicating to the user that information displayed in the display field F84 is the number of products information. In the example illustrated in FIG. 5, nothing is displayed in the display field F84. This is because the lot identification information is not input to the input field F61 in the lot movement image P4 illustrated in FIG. 5.

The display field F85 is a field in which injection molding device identification information for identifying an injection molding device that molded the product of the moving destination lot identified by the lot identification information input to the input field F61 or an injection molding device scheduled to mold the product of the lot is displayed. “Molding device”, which is a character string superimposed on the display field F85 in FIG. 5, is a character string for indicating to the user that information displayed in the display field F85 is the injection molding device identification information. In the example, nothing is displayed in the display field F85. This is because the lot identification information is not input to the input field F61 in the lot movement image P4 illustrated in FIG. 5.

The display field F86 is a field in which die identification information for identifying a die attached to the injection molding device that molded the product of the moving destination lot identified by the lot identification information input to the input field F61 or a die to be attached to the injection molding device scheduled to mold the product of the lot is displayed. “Die”, which is a character string superimposed on the display field F86 in FIG. 5, is a character string for indicating to the user that information displayed in the display field F86 is the die identification information. In the example, nothing is displayed in the display field F86. This is because the lot identification information is not input to the input field F61 in the lot movement image P4 illustrated in FIG. 5.

The display field F87 is a field in which number of cavities information indicating the number of cavities of the die indicated by the die identification information input to the display field F86 is displayed. “Cav No.”, which is a character string superimposed on the display field F87 in FIG. 5, is a character string for indicating to the user that information displayed in the display field F87 is the number of cavities information. In the example illustrated in FIG. 5, nothing is displayed in the display field F87. This is because the lot identification information is not input to the input field F61 in the lot movement image P4 illustrated in FIG. 5.

The display field F88 is a field in which the lot identification information after movement is displayed when the lot identification information after movement is generated. “Lot No after movement”, which is a character string superimposed on the display field F88 in FIG. 5, is a character string for indicating to the user that information displayed in the display field F88 is the lot identification information after movement. In the example illustrated in FIG. 5, nothing is displayed in the display field F88. This is because the lot identification information is not input to the input field F61 in the lot movement image P4 illustrated in FIG. 5.

Here, as illustrated in FIG. 6, when the lot identification information for identifying the moving destination lot is input to the input field F61, lot identification information after movement generated anew by the server 30 is displayed in the display field F88. In the example illustrated in FIG. 6, since the lot identification information input to the input field F61 is “2345678901”, “23456789011” is displayed in the display field F88 as the lot identification information after movement. In this case, information corresponding to the lot information indicating the moving destination lot is displayed in each of the display field F81 to the display field F87. In the example, “component 1” is displayed in the display field F81 as product type information indicating a type of the product of the moving destination lot. In the example, “shipping inspection SB1” is displayed in the display field F82 as process information indicating a work process currently performed on the product of the moving destination lot. In the example, “completed” indicating lot completed is displayed in the display field F83 as lot state information indicating a state of the moving destination lot. In the example, “10” indicating ten products is displayed in the display field F84 as number of products information indicating the number of products of the moving destination lot, the number being a number before the movement of the product is performed. In the example, “A-1” is displayed in the display field F85 as injection molding device identification information for identifying an injection molding device that molded the product of the moving destination lot or an injection molding device scheduled to mold the product of the lot. In addition, in the example, “die 1” is displayed in the display field F86 as die identification information for identifying a die attached to the injection molding device that molded the product of the moving destination lot or a die to be attached to the injection molding device scheduled to mold the product of the lot. In the example, “2” indicating two cavities is displayed in the display field F87 as number of cavities information indicating the number of cavities of the die.

The number of products to be moved reception region RG6 includes a GUI to which number of products to be moved information indicating the number of products moved between two lots is input. The number of products to be moved reception region RG6 may include, instead of this or in addition to this, another GUI to which the number of products to be moved information indicating the number of products moved between the two lots is input.

In the example illustrated in FIG. 5, the number of products to be moved reception region RG6 includes an input field F91 as a GUI to which the number of products to be moved information indicating the number of products moved between the two lots is input. The GUI may include, instead of the input field F91 or in addition to the input field F91, another GUI to which the number of products to be moved information indicating the number of products moved between the two lots is input. The input field F91 is an example of a number of products to be moved designation image.

The input field F91 is a field to which number of products to be moved information indicating the number of products moved between the two lots is input. “Number of products to be moved”, which is a character string superimposed on the input field F91 in FIG. 5, is a character string for indicating to the user that the information input to the input field F91 is the number of products to be moved information. In the example illustrated in FIG. 5, nothing is input to the input field F91. The input of the number of products to be moved information to the input field F91 may be performed according to selection of the number of products to be moved information by a pull-down menu or may be directly performed by an input device such as a keyboard.

In the example illustrated in FIG. 5, a button B51 is included in the number of products to be moved reception region RG6.

The button B51 is a button for receiving operation for deciding the movement of the product between the two lots. When selection operation on the button B51 is performed, the server 30 decides the lot identified by the lot identification information input to the input field F61 as a moving destination lot and changes lot identification information of the moving destination lot to the lot identification information after movement displayed in the display field F88. That is, in this case, the server 30 changes the lot identification information included in the lot information indicating the moving destination lot to the lot identification information after movement. Then, the server 30 generates number of products information indicating a number obtained by adding the number indicated by the number of products to be moved information input to the input field F91 to the number indicated by the number of products information included in the lot information and changes the number of products information included in the lot information to the generated number of products information. The server 30 decides the lot identified by the lot identification information input to the input field F31 as a moving source lot, generates number of products information indicating a number obtained by subtracting the number indicated by the number of products to be moved information input to the input field F91 from the number indicated by the number of products information included in the lot information indicating the moving source lot, and changes the number of products information included in the lot information to the generated number of products information. Further, the server 30 adds, to each of the lot information indicating the moving source lot and the lot information indicating the moving destination lot, history information indicating a history of the movement of the product between the two lots. That is, the server 30 stores the history information in association with the lot identification information indicated by each of the two pieces of lot information. Accordingly, the server 30 completes the movement of the product between the two lots. Since the movement of the products between the two lots can be performed as explained above, the server 30 can prevent a difference from occurring between an actual lot on which the product is moved and a lot on the molding management system 1. In the following explanation, for convenience of explanation, these kinds of processing executed by the server 30 when the selection operation on the button B51 is performed is referred to as movement decision processing. In the following explanation, for convenience of explanation, the movement decision processing being performed is referred to as the movement of the product between the two lots being decided.

Here, when the number of products to be moved information is not input to the input field F91, the server 30 grays out the button B51 and does not receive selection operation on the button B51 as illustrated in FIG. 5. On the other hand, when the number of products to be moved information is input to the input field F91, the server 30 releases the gray-out of the button B51 and receives the selection operation on the button B51. According to such gray-out, the server 30 can suppress erroneous operation by the user.

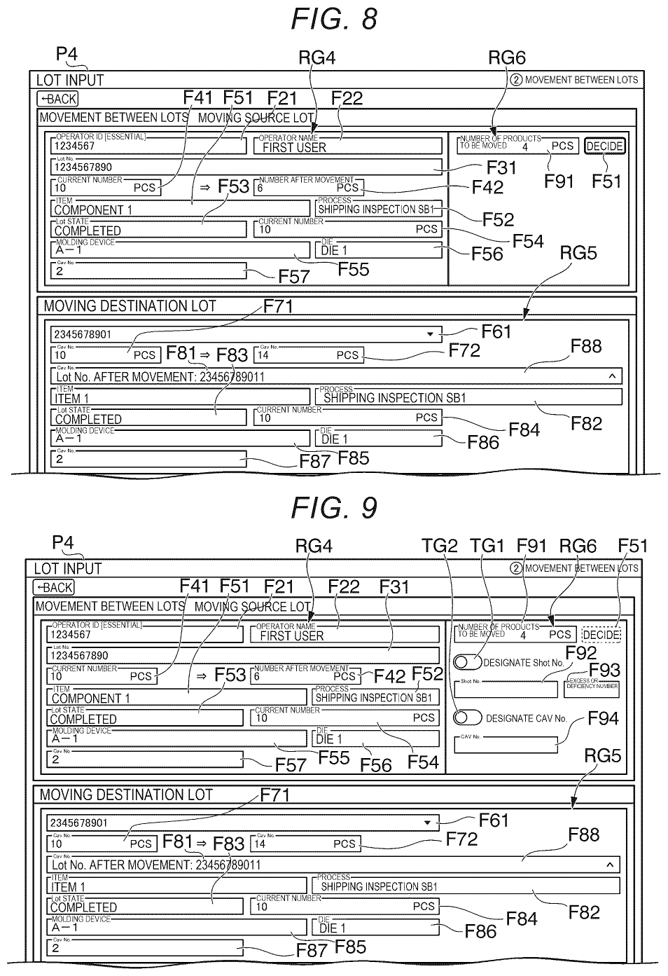

FIG. 8 is a diagram illustrating an example of a state in which the gray-out of the button B51 is released by the number of products to be moved information being input to the input field F91. In the example illustrated in FIG. 8, “4” indicating that the number of products to be moved between the two lots is four is input to the input field F91 as the number of products to be moved information. For this reason, in FIG. 8, the gray-out of the button B51 is released. The state of the lot movement image P4 illustrated in FIG. 8 is a state before the selection operation on the button B51 is performed. Therefore, in the example illustrated in FIG. 8, the movement of the product between the two lots is not decided. That is, in the example, the movement decision processing explained above is not performed.

When the number of products to be moved information is input to the input field F91 as illustrated in FIG. 8, in addition to the processing of releasing the gray-out of the button B51, the server 30 displays, in the display field F42, the number of products information indicating the number of products of the moving source lot in the case in which the movement of the product between the two lots is decided. The number of products of the moving source lot before the movement is decided is ten as indicated by the number of products information displayed in the display field F41. On the other hand, the number of products of the moving source lot in the case in which the movement is decided is a number obtained by subtracting the number indicated by the number of products to be moved information input to the input field F91 from the number indicated by the number of products information displayed in the display field F41, that is, six obtained by subtracting four from ten. Therefore, when the number of products to be moved information is input to the input field F91 as illustrated in FIG. 8, the server 30 displays “6” indicating six products in the display field F42. In the case, in addition to the processing, the server 30 displays, in the display field F72, the number of products information indicating the number of products of the moving destination lot in the case in which the movement is decided. The number of products of the moving destination lot before the movement is decided is ten as indicated by the number of products information displayed in the display field F71. On the other hand, the number of products of the moving destination lot in the case in which the movement is decided is the number obtained by adding the number indicated by the number of products to be moved information input to the input field F91 to the number indicated by the number of products information displayed in the display field F71, that is, fourteen obtained by adding four to ten. Therefore, when the number of products to be moved information is input to the input field F91 as illustrated in FIG. 8, the server 30 displays “14” indicating fourteen products in the display field F72. Since the number of products information in the display field F42 and the display field F72 as explained above is displayed, the server 30 can easily check whether the number of products is a desired number in each of the moving source lot and the moving destination lot before the movement of the product between the two lots is decided.

When the number indicated by the number of products to be moved information input to the input field F91 coincides with the number indicated by the number of products information displayed in the display field F54, the server 30 executes the movement decision processing when the selection operation on the button B51 is performed and the lot state information coincides the moving source lot and the moving destination lot. In addition to the execution of the movement decision processing, the server 30 changes the lot state information indicating the state of the moving source lot to lot state information indicating lot completed. In other words, when the number indicated by the number of products to be moved information input to the input field F91 is a total number of products of the moving source lot, in addition to the movement decision processing, the server 30 changes the lot state information indicating the state of the moving source lot to the lot state information indicating lot completed. Such change of the lot state information is performed regardless of whether the state of the moving source lot is in any state. As a result, the server 30 couples the moving source lot to the moving destination lot. That is, regardless of whether the state of the moving source lot is any state, the server 30 handles the products of the moving source lot and the moving destination lot as products of the moving destination lot. Accordingly, the server 30 can also prevent a difference from occurring between a coupled actual lot and a lot in the molding management system 1. On the other hand, when the number indicated by the number of products to be moved information input to the input field F91 coincides the number indicated by the number of products information displayed in the display field F54, even if the selection operation on the button B51 is performed, the server 30 rejects the execution of the movement decision processing because of an error or the like when the lot state information does not coincide between the moving source lot and the moving destination lot. This is because the state of the moving destination lot has to coincide with the state of the moving source lot. The server 30 may be configured to execute the movement decision processing when the selection operation on the button B51 is performed when the number indicated by the number of products to be moved information input to the input field F91 coincides the number indicated by the number of products information displayed in the display field F54 regardless of whether the lot state information coincides between the moving source lot and the moving destination lot.

The server 30 can also perform the movement of the product between the two lots explained above even between two lots belonging to manufacturing lots different from each other. This is also evident from, as explained above, the fact that extraction of a lot according to a manufacturing lot is not performed in each of the selection of the moving source lot and the selection of the moving destination lot. The server 30 may be configured to be capable of moving a product between two lots belonging to the same manufacturing lot.

With products of respective one or more lots managed by the molding management system 1, product related information concerning the products may be associated. In this case, with a certain product, product related information concerning the product is associated. Specifically, in this case, the product related information is associated with the product by being associated with lot identification information included in lot information indicating a lot of the product. For this reason, lot information indicating a certain lot includes product related information concerning each of products of the lot. That is, the product related information is associated with lot identification information included in the lot information.

Here, the product related information associated with the certain product is information including, together with product identification information for identifying the product, at least one of shot identification information for identifying a shot in which the product was molded and cavity identification information for identifying a cavity in which the product was molded. For this reason, the product related information may include other information concerning the product.

For example, when the product related information is included in the lot information indicating the certain lot and both of the shot identification information and the cavity identification information are included in the product related information, in addition to the input field F91 and the button B51, each of the input field F92 for receiving the shot identification information for identifying the shot in which the product of the moving source lot was molded, the display field F93 displayed incidentally to the input field F92, and the input field F94 for receiving the cavity identification information for identifying the cavity in which the product was molded is displayed in the number of products to be moved reception region RG6. FIG. 9 is a diagram illustrating another example of the lot movement image P4. In the example illustrated in FIG. 9, further, each of a toggle switch TG1 for receiving operation of selecting whether to permit input of information to the input field F92 and a toggle switch TG2 for receiving operation of selecting whether to permit input of information to the input field F94 is displayed in the number of products to be moved reception region RG6. When receiving, via the toggle switch TG1, operation of selecting not permitting to input information to the input field F92, the server 30 changes a display mode of the toggle switch TG1 to a display mode indicating that not permitting to input information to the input field F92 has been selected. Then, the server 30 grays out the input field F92 and does not receive operation on the input field F92. On the other hand, when the server 30 receives, via the toggle switch TG1, operation of selecting permitting to input information to the input field F92, the server 30 changes the display mode of the toggle switch TG1 to a display mode indicating that permitting to input information to the input field F92 has been selected. Then, the server 30 releases the gray-out of the input field F92 and receives operation on the input field F92. The toggle switch TG1 illustrated in FIG. 9 indicates that not permitting to input information to the input field F92 is selected by the toggle switch TG1. When receiving, via the toggle switch TG2, operation of selecting not permitting to input information to the input field F94, the server 30 changes a display mode of the toggle switch TG2 to a display mode indicating that not permitting to input information to the input field F94 has been selected. Then, the server 30 grays out the input field F94 and does not receive operation on the input field F94. On the other hand, when receiving, via the toggle switch TG2, operation of selecting permitting to input information to the input field F94, the server 30 changes the display mode of the toggle switch TG2 to a display mode indicating that permitting to input information to the input field F94 has been selected. Then, the server 30 releases the gray-out of the input field F94 and receives operation on the input field F94. The toggle switch TG2 illustrated in FIG. 9 indicates that not permitting to input information to the input field F94 is selected by the toggle switch TG2.

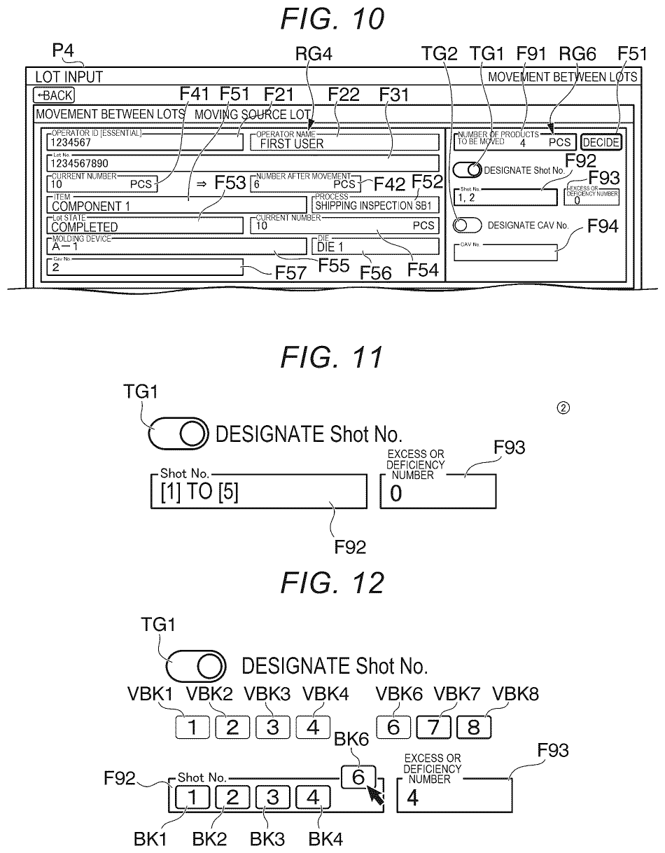

FIG. 10 is a diagram illustrating an example of a state of the number of products to be moved reception region RG6 in the case in which permitting to input information to the input field F92 has been selected by the toggle switch TG1. In this case, as illustrated in FIG. 10, the display mode of the toggle switch TG1 changes from the display mode of the toggle switch TG1 illustrated in FIG. 9. The gray-out of the input field F92 is released.

The input field F92 is a field to which shot identification information for identifying a shot that formed each of products to be moved to the moving destination lot among the products of the moving source lot is input. “Shot No.”, which is a character string superimposed on the input field F92 in FIGS. 9 and 10, is a character string for indicating to the user that information input to the input field F92 is the shot identification information. In the example illustrated in FIG. 10, “1” and “2” are input to the input field F92 as shot identification information. The “1” means a first shot. The “2” means a second shot. That is, in the example, the shot identification information input to the input field F92 means that each of the products to be moved to the moving destination lot among the products of the moving source lot is a product molded by each of the first shot and the second shot. As explained above, in the example, shot identification information for identifying each of one or more shots is divided with commas and input to the input field F92. In this case, the input of the shot identification information to the input field F92 is performed by direct input by an input device such as a keyboard. The input field F92 is an example of an image for receiving operation of inputting the shot identification information.

The display field F93 is a field for displaying difference information indicating the difference between a number obtained by multiplying together the number of the shot identification information input to the input field F92 and the number indicated by the number of cavities information input to the display field F57 and the number indicated by the number of products to be moved information input to the input field F91. When the number of products to be moved information is input to the input field F91 and the shot identification information is input to the input field F92, the server 30 calculates the difference and displays difference information indicating the calculated difference in the display field F93. Accordingly, the server 30 can cause the user to easily check whether the number of products molded by a shot designated by the user and the number of products that the user is about to move from the moving source lot to the moving destination lot coincide. As a result, the server 30 can prevent a difference between an actual lot in which a product is moved and a lot on the molding management system 1 from being caused by erroneous operation.

When the difference information displayed in the display field F93 indicates 0, when the movement of the product between the two lots is decided according to the selection operation on the button B51, the server 30 further specifies the shot identification information input to the input field F92. After specifying the shot identification information, the server 30 changes the lot identification information, with which product related information including the specified shot identification information is associated, to the lot identification information after movement displayed in the display field F88. The server 30 may be configured to perform such processing of changing the lot identification information in parallel to the movement decision processing or may be configured to perform the processing in a predetermined order. When generating the history information explained above in the movement decision processing, the server 30 generates the history information to indicate a history of the processing as well. Accordingly, by checking the history information, the user can specify by which shot each of products moved from the moving source lot to the moving destination lot was molded. That is, the server 30 can improve traceability in such movement of the lots.

Here, a method of inputting the shot identification information to the input field F92 may be another method. For example, the method of inputting the shot identification information to the input field F92 may be a method illustrated in FIG. 11. FIG. 11 is a diagram illustrating another example of the method of inputting the shot identification information to the input field F92 illustrated in FIG. 10. FIG. 11 is an enlarged view around the input field F92.

In the example illustrated in FIG. 11, “[1] to [5]” are input to the input field F92 as the shot identification information. The “[1] to [5]” means a first shot to a fifth shot. That is, in the example, a range of shots identified by the shot identification information is input to the input field F92. However, in this case, as illustrated in FIGS. 10 and 11, the shot identification information is desirably a number indicating the order of shots. Accordingly, the server 30 can reduce time and effort for the user to input the shot identification information.

A method of inputting the shot identification information to the input field F92 may be another method. For example, the method of inputting the shot identification information to the input field F92 may be a method as illustrated in FIG. 12. FIG. 12 is a diagram illustrating still another example of the method of inputting the shot identification information to the input field F92 illustrated in FIG. 10. FIG. 12 is an enlarged view around the input field F92.

In the example illustrated in FIG. 12, above the input field F92, a plurality of images that show shot identification information indicating a shot in which each of the products of the moving source lot was molded and can be dragged and dropped are displayed. Each of images BK1 to BK4 and the images BK6 to BK8 illustrated in FIG. 12 indicates an example of the plurality of images. Specifically, when n is any integer of 1 to 10, an image BKn indicates shot identification information for identifying an n-th shot. In the example illustrated in FIG. 12, the images BK1 to BK4 are input to the input field F92 by drag-and-drop. This means that shot identification information for identifying each of a first shot to a fourth shot is input to the input field F92. In the example, a state in which the image BK6 is dragged to the input field F92 is illustrated. Here, when the image BKn is dragged in the number of products to be moved reception region RG6, the server 30 displays an image indicating that the image BKn was located at a part where the image BKn was located before being dragged. An image VBKn is an example of an image indicating that the image BKn was located. Specifically, for example, an image VBK1 is an image indicating that the image BK1 was located. Accordingly, the user can return, with drag-and-drop, the image BKn erroneously input to the input field F92 to an original position and easily release the input to the input field F92. The movement of the image BKn to the input field F92 may be performed by, instead of the drag-and-drop, another method such as a method via a GUI that receives operation of causing the server 30 to perform the movement.

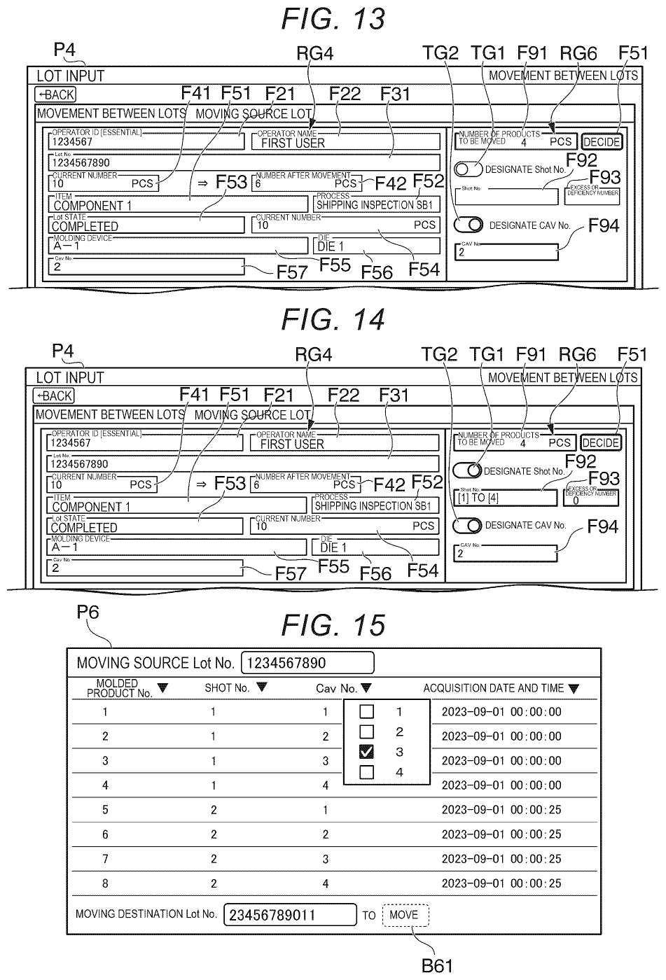

On the other hand, FIG. 13 is a diagram illustrating an example of a state of the number of products to be moved reception region RG6 in the case in which permitting to input information to the input field F94 has been selected by the toggle switch TG2. In this case, as illustrated in FIG. 13, the display mode of the toggle switch TG2 changes from the display mode of the toggle switch TG2 illustrated in FIG. 9. The gray-out of the input field F94 is released.

The input field F94 is a field to which cavity identification information for identifying a cavity that molded each of the products to be moved to the moving destination lot among the products of the moving source lot is input. “CAV No.”, which is a character string superimposed on the input field F94 in FIGS. 9 and 13, is a character string for indicating to the user that information input to the input field F94 is the cavity identification information. In the example illustrated in FIG. 13, “2” is input to the input field F94 as the cavity identification information. The “2” means a second cavity. That is, in the example, the cavity identification information input to the input field F94 means that each of the products to be moved to the moving destination lot among the products of the moving source lot is a product formed by the second cavity. As explained above, in the example, cavity identification information for identifying each of one or more cavities is divided by commas and input to the input field F94. In this case, the input of the cavity identification information to the input field F94 is performed by direct input by an input device such as a keyboard. In the example illustrated in FIG. 13, when the movement of the product between the two lots is decided, four products molded by the second cavity is moved from the moving source lot to the moving destination lot. For this reason, in the input field F94, a display field in which the difference information is displayed such as the display field F93 is displayed is not incidentally displayed. Note that a method of inputting the cavity identification information to the input field F94 may be another method such as input by drag-and-drop of a range of the cavity identification information and an image indicating the cavity identification information like the method of inputting the shot identification information to the input field F92. The input field F94 is an example of an image for receiving operation of inputting the cavity identification information.

When the cavity identification information is input to the input field F94, when the movement of the product between the two lots is decided according to the selection operation on the button B51, the server 30 further specifies the cavity identification information input to the input field F94. After specifying the cavity identification information, the server 30 selects, out of product related information including the specified cavity identification information, based on a predetermined selection rule, product related information by the number indicated by the number of products to be moved information input to the input field F91. After selecting the number of pieces of product related information, the server 30 changes lot identification information, with which the selected number of pieces of product related information are associated, to the lot identification information after movement displayed in the display field F88. The server 30 may be configured to perform such processing of changing the lot identification information in parallel to the movement decision processing or may be configured to perform the processing in a predetermined order. The selection rule may be a rule for randomly selecting the number of pieces of product related information, may be a rule for selecting the number of pieces of product related information in order from the top, may be a rule for selecting the number of pieces of product related information in order from the bottom, or may be another rule capable of selecting the number of pieces of product related information. When generating the history information explained above in the movement decision processing, the server 30 generates the history information to indicate a history of the processing as well. Accordingly, by checking the history information, the user can specify by which cavity each of the products moved from the moving source lot to the moving destination lot was molded. That is, the server 30 can more reliably improve traceability in such movement of the lots.

Further, FIG. 14 is a diagram illustrating an example of a state of the number of products to be moved reception region RG6 in the case in which permitting to input information to the input field F92 is selected by the toggle switch TG1 and permitting to input information to the input field F94 is selected by the toggle switch TG2. In this case, as illustrated in FIG. 14, a display mode of the toggle switch TG1 and the toggle switch TG2 changes from the display mode of the toggle switch TG1 and the toggle switch TG2 illustrated in FIG. 9. The gray-out of the input field F92 and the input field F94 is released.

When the shot identification information is input to the input field F92 and the cavity identification information is input to the input field F94, when the movement of the product between the two lots is decided according to the selection operation on the button B51, the server 30 specifies the shot identification information input to the input field F92 and specifies the cavity identification information input to the input field F94. After specifying the shot identification information and the cavity identification information, the server 30 specifies all combinations in which the specified shot identification information and the specified cavity identification information are combined one by one without overlap. After specifying all the combinations, the server 30 changes the lot identification information, with which product related information including each of all the combinations is associated, to the lot identification information after movement displayed in the display field F88. The server 30 may be configured to perform such processing of changing the lot identification information in parallel to the movement decision processing or may be configured to perform the processing in a predetermined order. When generating the history information explained above in the movement decision processing, the server 30 generates the history information to indicate a history of the processing as well. Accordingly, by checking the history information, the user can specify by which combination among combinations of shots and cavities each of the products moved from the moving source lot to the moving destination lot was molded. That is, the server 30 can more reliably improve traceability in such movement of the lots.

Here, in FIG. 14, in the number of products to be moved reception region RG6, the combination of the shot identification information input to the input field F92 and the cavity identification information input to the input field F94 may be narrowed down by searching. FIG. 15 is a diagram illustrating an example of a product search image P6 displayed by the server 30 in the case in which the user is about to perform input to the input field F92 and the input field F94. In the example illustrated in FIG. 15, a list of a plurality of pieces of product related information included in lot information indicating a moving source lot is displayed in the product search image P6. The product related information displayed in the product search image P6 illustrated in FIG. 15 includes product identification information for identifying products in order of being molded for each of products of the moving source lot, shot identification information for identifying a shot in which each of the products of the moving source lot was molded, cavity identification information indicating a cavity in which each of the products of the moving source lot was molded, and molding date and time information indicating a date and time when each of the products of the moving source lot was molded.

In an upper part of the list of the pieces of product related information displayed in the product search image P6, a pull-down menu indicating pieces of information included in the product related information is displayed. In the example illustrated in FIG. 15, four pull-down menus of “product No.▾”, “shot No.▾”, “Cav No.▾”, and “acquisition date and time▾” are displayed in the upper part. Here, the “product No. ▾” is a pull-down menu for selecting the product identification information for identifying the products in the order of molding for each of the products of the moving source lot. When selection operation on the “product No.▾” is performed, the server 30 displays a pull-down menu including a list of the product identification information. The “shot No.▾” is a pull-down menu for selecting the shot identification information for identifying the shot in which each of the products of the moving source lot was molded. When selection operation on the “shot No. ▾” is performed, the server 30 displays a pull-down menu including a list of the shot identification information. The “Cav No.▾” is a pull-down menu for selecting the cavity identification information for identifying the cavity in which each of the products of the moving source lot was molded. When selection operation on “Cav No.▾” is performed, the server 30 displays a pull-down menu including a list of the cavity identification information. The “acquisition date and time ▾” is a pull-down menu for selecting the molding date and time information indicating the date and time when each of the products of the moving source lot was molded. When selection operation on the “acquisition date and time▾” is performed, the server 30 displays a pull-down menu including a list of the molding date and time information.

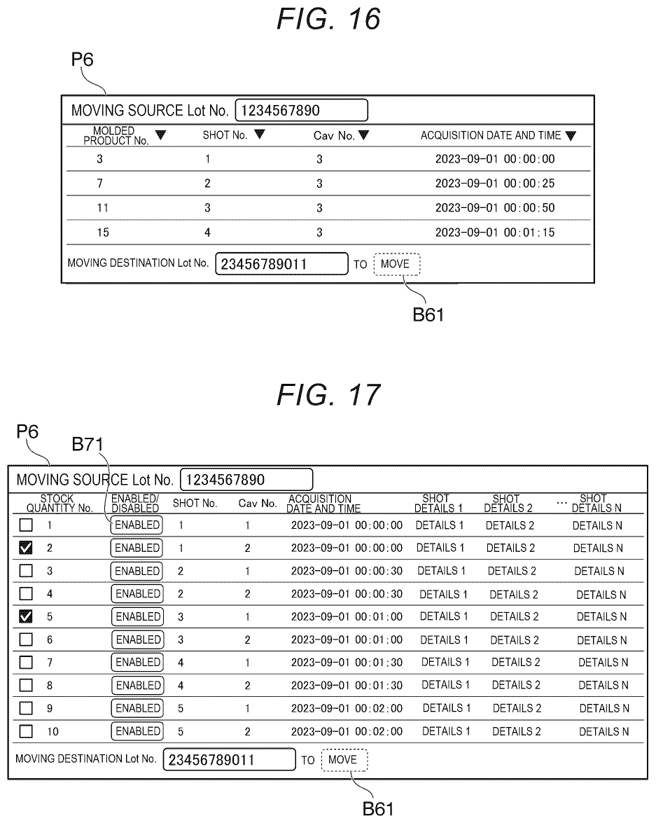

By selecting information from a desired pull-down menu among the four pull-down menus located in the upper part of the list of the product related information displayed in the product search image P6, the user can display, in the product search image P6, a list of product related information obtained as a result of searching for product related information concerning a desired product. In the example illustrated in FIG. 15, the user selects cavity identification information for identifying a third cavity with the selection operation on “Cav No. ▾.” Accordingly, the user can obtain a search result as illustrated in FIG. 16. FIG. 16 is a diagram illustrating an example of a result of a search performed according to the selection operation on the pull-down menu performed by the user in FIG. 15. In the example illustrated in FIG. 16, a list of product related information concerning a product molded by the third cavity in each of the first shot to the fourth shot is displayed.

As illustrated in FIGS. 15 and 16, the product search image P6 includes a button B61.

The button B61 is a button having the same function as the function of the button B51 in the number of products to be moved reception region RG6. For this reason, detailed explanation about the button B61 is omitted. When selection operation on the button B61 is performed, the server 30 specifies a list of pieces of product related information displayed in the product search image P6, that is, a combination of the shot identification information and the cavity identification information included in each of the pieces of product related information included in the search result. Then, the server 30 changes the lot identification information, with which the product related information including each of the combinations is associated, to the lot identification information after movement displayed in the display field F88. The server 30 may be configured to perform such processing of changing the lot identification information in parallel to the movement decision processing or may be configured to perform the processing in a predetermined order. When generating the history information explained above in the movement decision processing, the server 30 generates the history information to indicate a history of the processing as well. As explained above, also when the selection operation on the button B61 of the product search image P6 is performed, the server 30 performs the same processing as the processing performed when the selection operation on the button B51 in the number of products to be moved reception region RG6 is performed. As a result, even in the case, the server 30 can more reliably improve traceability in the movement of the product between the two lots.

In the product search image P6, a search by a search condition for a desired product that the user desires to move from the moving source lot to the moving destination lot among the products of the moving source lot may be performed.

In the product search image P6, desired product related information may be selected by the user out of the list of product related information for each of the products of the moving source lot. FIG. 17 is a diagram illustrating another example of the product search image P6. In the example illustrated in FIG. 17, the product search image P6 displays a list of pieces of product related information for each of the products of the moving source lot. In the example, a button for receiving operation of selecting whether to perform movement from the moving source lot to the moving destination lot is displayed incidentally in the pieces of product related information included in the list. For example, a button B71 illustrated in FIG. 17 is an example of the button for product related information displayed in the top part. In the example illustrated in FIG. 17, a display mode of the button B71 is a display mode indicating that the movement from the moving source lot to the moving destination lot is performed. For this reason, a character string “enabled” is displayed in the button B71. In the example, when it is indicated that the movement from the moving source lot to the moving destination lot is not performed, a character string “disabled” is displayed in the button B71. Whether the button B71 indicates that the movement from the moving source lot to the moving destination lot is performed is switched every time selection operation on the button B71 is performed. Accordingly, the user can easily select, out of the list, product related information about a desired product that the user desires to move from the moving source lot to the moving destination lot.

The server 30 that can cause the terminal device 40 to display the lot movement image P4 explained above is, for example, a workstation, a desktop PC (Personal Computer), a notebook PC, or the like but is not limited to these. The server 30 may be configured integrally with the information processing device 20.

The server 30 is communicably connected to the information processing device 20 by wired or wireless communication. A communication network connecting the server 30 and the information processing device 20 may be, for example, a LAN in a facility in which the plurality of managed devices 10 are installed, may be the Internet, may be a mobile communication network, or may be another communication network. In the following explanation, as an example, a case in which the communication network connecting the server 30 and the information processing device 20 is the Internet is explained. In this case, the server 30 is a cloud server.

The server 30 is communicably connected to the terminal device 40 by wired or wireless communication. In the example illustrated in FIG. 1, the server 30 is communicably connected to the terminal device 40 by wireless communication. A communication network connecting the server 30 and the terminal device 40 may be, for example, a LAN in a facility in which the server 30 is installed, the Internet, a mobile communication network, or another communication network. In the following explanation, as an example, a case in which the communication network connecting the server 30 and the terminal device 40 is the Internet is explained.

### Hardware Configuration of the Server

A hardware configuration of the server 30 is explained below with reference to FIG. 18. FIG. 18 is a diagram illustrating an example of the hardware configuration of the server 30.

The server 30 includes, for example, a processor 31, a storage unit 32, and a communication unit 33. These component elements are communicably connected to one another via a bus. The server 30 communicates with each of the information processing device 20 and the terminal device 40 via the communication unit 33.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the server 30, the storage unit 32 may be an external storage device connected to a digital input/output port such as a USB (Universal Serial Bus). The storage unit 32 stores various information, various images, and various programs to be processed by the server 30. That is, the various information stored by the server 30 are stored in the storage unit 32.

The communication unit 33 is a communication device including, for example, a digital input/output port such as a USB, an Ethernet (registered trademark) port, and an antenna for wireless communication.

### Functional Configuration of the Server

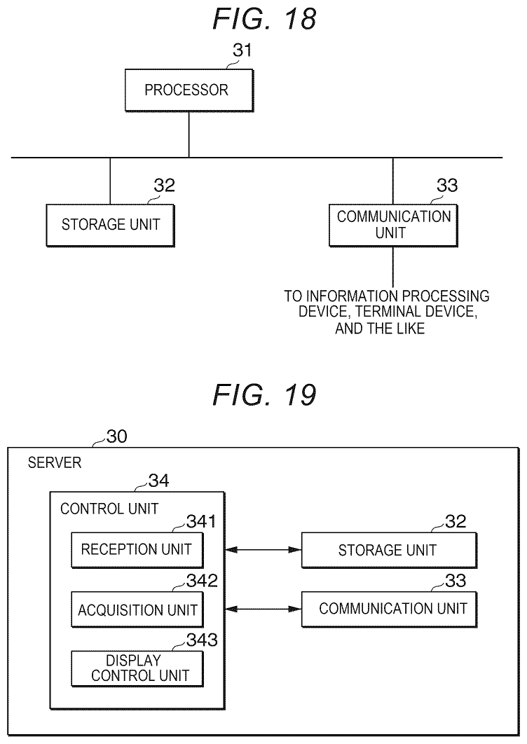

A functional configuration of the server 30 is explained below with reference to FIG. 19. FIG. 19 is a diagram illustrating an example of the functional configuration of the server 30.

The server 30 includes the storage unit 32, the communication unit 33, and a control unit 34.

The control unit 34 controls the entire server 30. The control unit 34 includes a reception unit 341, an acquisition unit 342, and a display control unit 343. These functional units provided in the control unit 34 are implemented by, for example, the processor 31 executing various programs stored in the storage unit 32. A part or all of the functional units may be hardware functional units such as a large scale integration (LSI) or an application specific integrated circuit (ASIC).

The reception unit 341 receives various information and various kinds of operation from a device communicably connected to the server 30.

The acquisition unit 342 acquires, for each of the plurality of managed devices 10, state information about the managed device 10 from the managed device 10 via the information processing device 20. The acquisition unit 342 may be configured to directly acquire the state information from the managed device 10 not via the information processing device 20.

The display control unit 343 generates various images according to operation received via the reception unit 341. The display control unit 343 transmits the generated images to the terminal device 40 and displays the images on the terminal device 40.

Processing in which the Server Moves a Product Between Two Lots

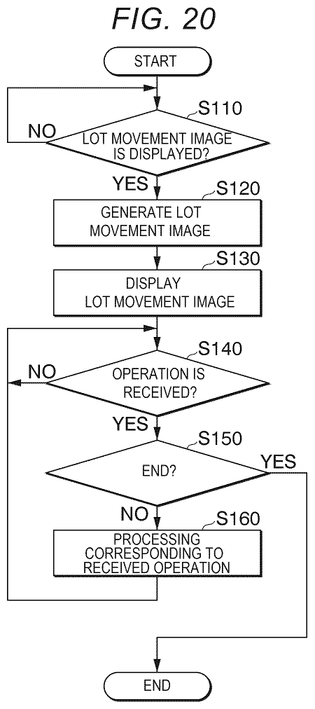

Referring to FIG. 20, processing in which the server 30 moves a product between two lots is explained. FIG. 20 is a diagram illustrating an example of a flow of processing in which the server 30 moves a product between two lots. In the following explanation, as an example, a case in which the lot search image P3 is displayed on the terminal device 40 at timing before the processing in step S110 illustrated in FIG. 20 is performed is explained. In the following explanation, as an example, a case in which each of master data and lot information are already stored in the server 30 at the timing is explained.

The control unit 34 stays on standby until operation of displaying the lot movement image P4 via the terminal device 40, that is, selection operation on the button B41 is received (step S110). In FIG. 20, the processing of step S110 is indicated by “lot movement image is displayed?.”

When determining that the operation of displaying the lot movement image P4 is received via the terminal device 40 (step S110-YES), the control unit 34 generates the lot movement image P4 (step S120). A method of generating the lot movement image P4 in step S120 may be a known method or may be a method to be developed in future.

Next, the control unit 34 transmits the lot movement image P4 generated in step S120 to the terminal device 40 and causes the terminal device 40 to display the lot movement image P4 (step S130).

Next, the control unit 34 stays on standby until operation is received via the lot movement image P4 displayed on the terminal device 40 (step S140). In FIG. 20, the processing in step S140 is indicated by “operation is received?.”

When determining that the operation has been received via the lot movement image P4 displayed on the terminal device 40 (step S140-YES), the control unit 34 determines whether the received operation is operation of ending the processing of the flowchart illustrated in FIG. 20 (step S150). The determination processing in step S150 by the control unit 34 may be performed by a known method or may be performed by a method to be developed in future. In FIG. 20, the processing in step S150 is indicated by “end?.”

When determining that the operation received in step S140 is the operation of ending the processing of the flowchart illustrated in FIG. 20 (step S150-YES), for example, the control unit 34 deletes the display of the lot movement image P4 from the terminal device 40 and ends the processing of the flowchart illustrated in FIG. 20.

On the other hand, when determining that the operation received in step S140 is not the operation of ending the processing of the flowchart illustrated in FIG. 20 (step S150-NO), the control unit 34 performs processing corresponding to the received operation (step S160). Here, since the processing performed by the control unit 34 in step S160 is already explained with reference to FIGS. 5 to 17, detailed explanation of the processing is omitted.

After the processing in step S160 is performed, the control unit 34 transitions to step S140 and stays on standby again until operation is received via the lot movement image P4 displayed on the terminal device 40.

According to the processing explained above, the server 30 displays the lot movement image P4 for receiving lot moving operation of moving a product between designated two lots among lots indicated by the plurality of pieces of lot information stored in the storage unit 32. Accordingly, the server 30 can prevent a difference from occurring between the actual lot in which the product is moved and a lot on the molding management system 1.

The molding management system 1 explained above may include the terminal device 40.

The search for a lot explained above may be performed using, as a search key, a time period in which the lot was not normally operating. In this case, the lot related information includes information indicating the time period.

The search for a lot explained above may be performed using, as a search key, one or more pieces of information included in the injection molding device related information. In this case, the lot related information includes the injection molding device related information. Injection molding device related information included in lot related information concerning a certain lot is information concerning an injection molding device that performs molding of a product of the lot and is information including, for example, operation state information indicating an operation state of the injection molding device and detection information about the injection molding device as explained above. Accordingly, the server 30 can more reliably improve traceability about a product.

The search for a lot explained above may be performed using any character string as a search key. In this case, the lot search image P3 includes an input field for the user to input a character string. When receiving a character string via the input field, the server 30 specifies information including the received character string out of one or more pieces of information included in the lot related information and displays, in the search result display region RG2, lot information indicating a lot identified by each of lot identification information associated with the specified information. Accordingly, the server 30 can make a search for a lot by the user easier.

The contents explained above may be combined in any manner.

APPENDIXES

APPENDIXES 1

A molding management system including a server communicably connected to a terminal device, the molding management system managing production of a product in a production process including an injection molding process for the product by an injection molding device, wherein the server includes: a storage unit configured to store a plurality of pieces of lot information in which lot identification information for identifying a lot of the product and lot related information including one or more pieces of information concerning the lot of the product are associated with each other; and a control unit configured to cause the terminal device to display a lot movement image for receiving lot moving operation for moving the product between a selected pair of the lots among the lots indicated by the plurality of pieces of lot information stored in the storage unit.

APPENDIXES 2

The molding management system described in [1], wherein the lot movement image includes a moving source selection image for receiving operation of selecting the lot of a moving source of the product as a moving source lot and a moving destination selection image for receiving operation of selecting the lot of a moving destination of the product as a moving destination lot, and the control unit receives the lot moving operation of moving the product from the moving source lot selected by the moving source selection image to the moving destination lot selected by the moving destination selection image in the lot movement image.

APPENDIXES 3

The molding management system described in [2], wherein, when receiving the lot moving operation, the control unit changes lot identification information about at least one of the moving destination lot and the moving source lot to new piece of the lot identification information.

APPENDIXES 4

The molding management system described in [2] or [3], wherein the lot movement image includes a number of products to be moved designation image for receiving operation of designating a number of the products to be moved from the moving source lot to the moving destination lot.

APPENDIXES 5

The molding management system described in [4], wherein, when the number of the products to be moved from the moving source lot to the moving destination lot is a total number of the products of the moving source lot, the control unit couples the moving source lot to the moving destination lot.

APPENDIXES 6

The molding management system described in any one of [2] to [5], wherein the lot movement image includes an image for receiving operation of inputting at least one of shot identification information for identifying a shot in which the product of the moving source lot was molded and cavity identification information for identifying a cavity in which the product of the moving source lot was molded.

APPENDIXES 7

The molding management system described in any one of [1] to [6], wherein the lot related information includes, as the one or more pieces of information, injection molding device related information concerning an injection molding device that performs molding of the product of the lot identified by the lot identification information associated with the lot related information, and the injection molding device related information includes at least one of operation state information indicating an operation state of the injection molding device and detection information detected by each of one or more sensors attached to the injection molding device. The injection molding device described in [7] may be the same injection molding device as the injection molding device described in [1] or may be an injection molding device different from the injection molding device described in [1]. Therefore, in [7], the is not added to injection molding device.

APPENDIXES 8

The molding management system described in any one of [1] to [7], wherein the lot related information includes quality information about the product of the lot identified by the lot identification information associated with the lot related information.

APPENDIXES 9

The molding management system described in any one of [1] to [8], wherein the lot related information includes process information indicating a work process currently performed on the product of the lot identified by the lot identification information associated with the lot related information.

APPENDIXES 10

The molding management system described in any one of [1] to [9], wherein the molding management system includes the terminal device.

APPENDIXES 11

The molding management system described in any one of [1] to [10], wherein the molding management system includes the injection molding device.

Although the embodiment of the present disclosure is explained in detail above with reference to the drawings, a specific configuration is not limited to the embodiment and may be, for example, changed, replaced, or deleted without departing from the gist of the present disclosure.

A program for implementing a function of any component in the device explained above may be recorded in a computer-readable recording medium and the program may be read and executed by a computer system. Here, the device is, for example, the injection molding device 11, the information processing device 20, the server 30, or the terminal device 40. Here, the “computer system” referred to here includes an operating system (OS) and hardware such as peripheral equipment. The “computer-readable recording medium” refers to a portable medium such as a flexible disc, a magneto-optical disc, a ROM, or a compact disk (CD)-ROM or a storage device such as a hard disk built in the computer system. Further, the “computer-readable recording medium” includes a medium that retains a program for a certain period of time like a volatile memory inside a computer system serving as a server or a client when a program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting the program refers to a medium including a function of transmitting information like a network such as the Internet or a communication line such as a telephone line.

The program may be a program for implementing a part of the functions explained above. Further, the program may be a so-called differential file or differential program that can implement the functions explained above in combination with a program already recorded in the computer system.

What is claimed is:

1. A molding management system comprising a server communicably connected to a terminal device, the molding management system managing production of a product in a production process including an injection molding process for the product by an injection molding device, wherein
the server includes:
a storage unit configured to store a plurality of pieces of lot information in which lot identification information for identifying a lot of the product and lot related information including one or more pieces of information concerning the lot of the product are associated with each other; and
a control unit configured to cause the terminal device to display a lot movement image for receiving lot moving operation for moving the product between a selected pair of the lots among the lots indicated by the plurality of pieces of lot information stored in the storage unit.

2. The molding management system according to claim 1, wherein
the lot movement image includes a moving source selection image for receiving operation of selecting the lot of a moving source of the product as a moving source lot and a moving destination selection image for receiving operation of selecting the lot of a moving destination of the product as a moving destination lot, and
the control unit receives the lot moving operation of moving the product from the moving source lot selected by the moving source selection image to the moving destination lot selected by the moving destination selection image in the lot movement image.

3. The molding management system according to claim 2, wherein, when receiving the lot moving operation, the control unit changes lot identification information about at least one of the moving destination lot and the moving source lot to new piece of the lot identification information.

4. The molding management system according to claim 2, wherein the lot movement image includes a number of products to be moved designation image for receiving operation of designating a number of the products to be moved from the moving source lot to the moving destination lot.

5. The molding management system according to claim 4, wherein, when the number of the products to be moved from the moving source lot to the moving destination lot is a total number of the products of the moving source lot, the control unit couples the moving source lot to the moving destination lot.

6. The molding management system according to claim 2, wherein the lot movement image includes an image for receiving operation of inputting at least one of shot identification information for identifying a shot in which the product of the moving source lot was molded and cavity identification information for identifying a cavity in which the product of the moving source lot was molded.

7. The molding management system according to claim 1, wherein
the lot related information includes, as the one or more pieces of information, injection molding device related information concerning an injection molding device that performs molding of the product of the lot identified by the lot identification information associated with the lot related information, and
the injection molding device related information includes at least one of operation state information indicating an operation state of the injection molding device and detection information detected by each of one or more sensors attached to the injection molding device.

8. The molding management system according to claim 1, wherein the lot related information includes quality information about the product of the lot identified by the lot identification information associated with the lot related information.

9. The molding management system according to claim 1, wherein the lot related information includes process information indicating a work process currently performed on the product of the lot identified by the lot identification information associated with the lot related information.

10. The molding management system according to claim 1, wherein the molding management system includes the terminal device.

11. The molding management system according to claim 1, wherein the molding management system includes the injection molding device.
